(19) United States
(12) Patent Application Publication
(10) Pub. No.: US 2025/0103708 A1
(43) Pub. Date: Mar. 27, 2025

(54) System, Method, and Computer Program Product for Energy Efficient Generation of Artificial Noise to Prevent Side-Channel Attacks

(71) Applicant: Visa International Service Association, San Francisco, CA (US)

(72) Inventors: Shan Jin, Georgetown, TX (US); Minghua Xu, Austin, TX (US); Mihai Christodorescu, San Carlos, CA (US)

(21) Appl. No.: 18/833,484

(22) PCT Filed: Jan. 27, 2023
(86) PCT No.: PCT/US2023/011705

§ 371 Date: Jul. 26, 2024

Related U.S. Application Data
(60) Provisional application No. 63/304,077, filed on Jan. 28, 2022.

(51) Int. Cl. G06F 21/55

(52) U.S. Cl. CPC G06F 21/554; G06F 2221/034

(57) ABSTRACT

Methods, systems, and computer program products are provided for energy efficient generation of artificial noise to prevent side-channel attacks. An example method includes storing at least one secret value including secret value bits. At least one cryptographic operation is executed based on the at least one secret value. An artificial sequence generator stores at least one state indication based on a plurality of previous cryptographic operations executed on the device. A plurality of samples of artificial noise are generated, and a number of the plurality of samples is based on at least one power constraint parameter. Each sample of artificial noise of the plurality of samples of artificial noise is overlaid over a respective portion of a side channel signal based on the at least one state indication to mask leakage information associated with the at least one secret value on the side channel signal.

### CROSS REFERENCE TO RELATED APPLICATIONS

This application is the United States national phase of International Patent Application No. PCT/US2023/011705 filed Jan. 27, 2023, and claims priority to U.S. Provisional Patent Application No. 63/304,077 filed Jan. 28, 2022, the disclosures of which are hereby incorporated by reference in their entireties.

### BACKGROUND

### 1. Technical Field

This disclosure relates generally to preventing side-channel attacks (SCAs) and, in some non-limiting embodiments or aspects, systems, methods, and computer program products for energy efficient generation of artificial noise to mask side-channel leakage used for side-channel attacks.

### 2. Technical Considerations

SCAs aim at extracting secrets from a chip or a system through measurement and analysis of physical parameters. Examples of such parameters include supply current, execution time, and electromagnetic emission. These parameters are then used to infer information about secrets involved in cryptographic processing. For example, SCAs are used to gather observed information that can be used to infer secret keys, secret passwords, secret instructions, etc., based on the observable leakage of physical parameters emitted from cryptographic implementations or devices. SCAs have been increasingly successful in recovering secret values from devices or cryptographic implementations that are exposed to attackers in general. These attacks pose a serious threat to modules that integrate cryptographic systems, as many side-channel analysis techniques have proven successful in breaking an algorithmically robust cryptographic operation (for example, encryption) and extracting the secret values therein (e.g., a secret key, etc.).

Recent breakthroughs have proven successful at using physical parameters such as the power consumption in SCAs against modern cryptographic devices. For example, such SCAs include using electromagnetic signals to break the Elliptic Curve Digital Signature Algorithm (ECDSA) in Google Titan. In another example, an SCA was successful using the measured power consumption to extract the master key from a physical electronic authorization device used to control access to a resource (e.g., smart cards, chip cards, or integrated circuit cards (IC card), etc.). More recently, an increasing variety of applications hosted on such devices are under the threats of secure-channel attack (e.g., digital wallet applications, digital identity applications, etc.). Security of payment devices is vital to the payment industry. However, existing systems have not provided solutions for optimizing protections to efficiently block a side-channel leakage that can prevent an attack.

### SUMMARY

Accordingly, provided are improved systems, methods, and computer program products for energy efficient generation of artificial noise to mask side-channel leakage used for side-channel attacks (SCAs).

According to non-limiting embodiments or aspects, provided is a computer-implemented method, comprising: storing, with a device, at least one secret value comprising secret value bits; executing, with a cryptographic subsystem of the device, at least one cryptographic operation based on the at least one secret value; storing, with an artificial sequence generator, at least one state indication based on a plurality of previous cryptographic operations executed on the device; generating, with the artificial sequence generator, a plurality of samples of artificial noise, wherein a number of the plurality of samples is based on at least one power constraint parameter; and overlaying, with the artificial sequence generator, each sample of artificial noise of the plurality of samples of artificial noise over a respective portion of a side channel signal based on the at least one state indication to mask leakage information associated with the at least one secret value on the side channel signal.

In some non-limiting embodiments or aspects, generating the plurality of samples of artificial noise comprises generating the plurality of samples of artificial noise based on a Gaussian random vector, a selection matrix, and a signal constraint parameter, wherein the at least one power constraint parameter comprises the signal constraint parameter and a rank parameter, and wherein the selection matrix comprises a diagonal matrix having a rank less than the rank parameter.

In some non-limiting embodiments or aspects, the signal constraint parameter comprises a direct current (DC) component and an alternating current (AC) component.

In some non-limiting embodiments or aspects, the computer-implemented method, wherein the at least one state indication comprises a plurality of state indications, each state indication of the plurality of state indications associated with a respective time that the cryptographic subsystem is processing the at least one secret value during execution of the at least one cryptographic operation, and overlaying each sample of artificial noise of the plurality of samples of artificial noise comprises overlaying each sample of artificial noise over the respective portion of the side channel signal based on the respective time that the cryptographic subsystem is processing the at least one secret value.

In some non-limiting embodiments or aspects, the side channel signal comprises a signal on a side channel, the side channel having a channel capacity that is logarithmically proportional to a signal-to-noise ratio (SNR) of the side channel, the SNR being inversely proportional to each respective sample of artificial noise, wherein overlaying each respective sample of artificial noise comprises reducing the channel capacity by reducing the SNR.

In some non-limiting embodiments or aspects, the computer-implemented method may further include predicting with the artificial sequence generator, an approximate time during which the cryptographic subsystem will be executing the at least one cryptographic operation based on the at least one state indication.

In some non-limiting embodiments or aspects, predicting the approximate time comprises generating the plurality of samples of artificial noise based on a random vector and a sample rate for overlaying each sample of artificial noise over the respective portion of the side channel signal.

In some non-limiting embodiments or aspects, the computer-implemented method may further include selecting a number of the plurality of samples of artificial noise based on a rank of a selection matrix and the at least one power constraint.

In some non-limiting embodiments or aspects, a leakage trace available on a side channel of the side channel signal comprises a linear combination of an original leakage trace resulting from the cryptographic subsystem executing the at least one cryptographic operation, naturally occurring noise on the side channel, and the plurality of samples of artificial noise.

In some non-limiting embodiments or aspects, the side channel signal comprises a power signal.

In some non-limiting embodiments or aspects, the side channel signal comprises an electromagnetic signal.

Further non-limiting embodiments or aspects are set forth in the following numbered clauses:

Clause 1: A computer-implemented method, comprising: storing, with a device, at least one secret value comprising secret value bits; executing, with a cryptographic subsystem of the device, at least one cryptographic operation based on the at least one secret value; storing, with an artificial sequence generator, at least one state indication based on a plurality of previous cryptographic operations executed on the device; generating, with the artificial sequence generator, a plurality of samples of artificial noise, wherein a number of the plurality of samples is based on at least one power constraint parameter; and overlaying, with the artificial sequence generator, each sample of artificial noise of the plurality of samples of artificial noise over a respective portion of a side channel signal based on the at least one state indication to mask leakage information associated with the at least one secret value on the side channel signal.

Clause 2: The computer-implemented method of clause 1, wherein generating the plurality of samples of artificial noise comprises generating the plurality of samples of artificial noise based on a Gaussian random vector, a selection matrix, and a signal constraint parameter, wherein the at least one power constraint parameter comprises the signal constraint parameter and a rank parameter, and wherein the selection matrix comprises a diagonal matrix having a rank less than the rank parameter.

Clause 3: The computer-implemented method of clauses 1 or 2, wherein the signal constraint parameter comprises a direct current (DC) component and an alternating current (AC) component.

Clause 4: The computer-implemented method of any of clauses 1-3, wherein the at least one state indication comprises a plurality of state indications, each state indication of the plurality of state indications associated with a respective time that the cryptographic subsystem is processing the at least one secret value during execution of the at least one cryptographic operation, and wherein overlaying each sample of artificial noise of the plurality of samples of artificial noise comprises overlaying each sample of artificial noise over the respective portion of the side channel signal based on the respective time that the cryptographic subsystem is processing the at least one secret value.

Clause 5: The computer-implemented method of any of clauses 1-4, wherein the side channel signal comprises a signal on a side channel, the side channel having a channel capacity that is logarithmically proportional to a signal to noise ratio (SNR) of the side channel, the SNR being inversely proportional to each respective sample of artificial noise, wherein overlaying each respective sample of artificial noise comprises reducing the channel capacity by reducing the SNR.

Clause 6: The computer-implemented method of any of clauses 1-5, further comprising predicting with the artificial sequence generator, an approximate time during which the cryptographic subsystem will be executing the at least one cryptographic operation based on the at least one state indication.

Clause 7: The computer-implemented method of any of clauses 1-6, wherein predicting the approximate time, comprises: generating the plurality of samples of artificial noise based on a random vector and a sample rate for overlaying each sample of artificial noise over the respective portion of the side channel signal.

Clause 8: The computer-implemented method of any of clauses 1-7, further comprising: selecting a number of the plurality of samples of artificial noise based on a rank of a selection matrix and the at least one power constraint.

Clause 9: The computer-implemented method of any of clauses 1-8, wherein a leakage trace available on a side channel of the side channel signal comprises a linear combination of an original leakage trace resulting from the cryptographic subsystem executing the at least one cryptographic operation, naturally occurring noise on the side channel, and the plurality of samples of artificial noise.

Clause 10: The computer-implemented method of any of clauses 1-9, wherein the side channel signal comprises a power sign or an electromagnetic signal.

Clause 11: A system, comprising: at least one processor; and at least one non-transitory computer readable medium comprising one or more instructions that, when executed by the at least one processor, cause the at least one processor to: store at least one secret value comprising secret value bits; execute at least one cryptographic operation based on the at least one secret value; store at least one state indication based on a plurality of previous cryptographic operations executed on a device; generate a plurality of samples of artificial noise, wherein a number of the plurality of samples is based on at least one power constraint parameter; and overlay each sample of artificial noise of the plurality of samples of artificial noise over a respective portion of a side channel signal based on the at least one state indication to mask leakage information associated with the at least one secret value on the side channel signal.

Clause 12: The system of clause 11, wherein the one or more instructions, when executed by the at least one processor, further cause the at least one processor to generate the plurality of samples of artificial noise based on a Gaussian random vector, a selection matrix, and a signal constraint parameter, wherein the at least one power constraint parameter comprises the signal constraint parameter and a rank parameter, and wherein the selection matrix comprises a diagonal matrix having a rank less than the rank parameter.

Clause 13: The system of clauses 11 or 12, wherein the signal constraint parameter comprises a direct current (DC) component and an alternating current (AC) component.

Clause 14: The system of any of clauses 11-13, wherein the at least one state indication comprises a plurality of state indications, each state indication of the plurality of state indications associated with a respective time that the cryptographic subsystem is processing the at least one secret value during execution of the at least one cryptographic operation, and wherein overlaying each sample of artificial noise of the plurality of samples of artificial noise comprises overlaying each sample of artificial noise over the respective portion of the side channel signal based on the respective time that the cryptographic subsystem is processing the at least one secret value.

Clause 15: The system of any of clauses 11-14, wherein the side channel signal comprises a signal on a side channel, the side channel having a channel capacity that is logarithmically proportional to a signal to noise ratio (SNR) of the side channel, the SNR being inversely proportional to each respective sample of artificial noise, wherein overlaying each respective sample of artificial noise comprises reducing the channel capacity by reducing the SNR.

Clause 16: The system of any of clauses 11-15, wherein the one or more instructions, when executed by the at least one processor, further cause the at least one processor to: predict an approximate time during which the cryptographic subsystem will be executing the at least one cryptographic operation based on the at least one state indication.

Clause 17: The system of any of clauses 11-16, wherein the one or more instructions, when executed by the at least one processor, further cause the at least one processor to: generate the plurality of samples of artificial noise based on a random vector and a sample rate for overlaying each sample of artificial noise over the respective portion of the side channel signal.

Clause 18: The system of any of clauses 11-17, wherein the one or more instructions, when executed by the at least one processor, further cause the at least one processor to: select a number of the plurality of samples of artificial noise based on a rank of a selection matrix and the at least one power constraint.

Clause 19: The system of any of clauses 11-18, wherein a leakage trace available on a side channel of the side channel signal comprises a linear combination of an original leakage trace resulting from the cryptographic subsystem executing the at least one cryptographic operation, naturally occurring noise on the side channel, and the plurality of samples of artificial noise.

Clause 20: A computer program product comprising at least one non-transitory computer-readable medium having instructions stored thereon that, when executed by at least one computing device, cause the at least one computing device to: store at least one secret value comprising secret value bits; execute at least one cryptographic operation based on the at least one secret value; store at least one state indication based on a plurality of previous cryptographic operations executed on the device; generate a plurality of samples of artificial noise, wherein a number of the plurality of samples is based on at least one power constraint parameter; and overlay each sample of artificial noise of the plurality of samples of artificial noise over a respective portion of a side channel signal based on the at least one state indication to mask leakage information associated with the at least one secret value on the side channel signal.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure.

### BRIEF DESCRIPTION OF THE DRAWINGS

Additional advantages and details are explained in greater detail below with reference to the non-limiting, exemplary embodiments or aspects that are illustrated in the accompanying schematic figures, in which:

FIG. 1 is a schematic diagram of a system for energy efficient generation of artificial noise to prevent side-channel attacks according to some non-limiting embodiments or aspects;

FIG. 2 is a flow diagram for a method of generating artificial noise to prevent side-channel attacks according to some non-limiting embodiments or aspects;

FIG. 3 is a schematic diagram of a system for energy efficient generation of artificial noise to prevent side-channel attacks according to some non-limiting embodiments or aspects;

FIGS. 4A-4B are an illustration of a probability for energy efficient generation of artificial noise to prevent side-channel attacks according to some non-limiting embodiments or aspects;

FIGS. 5A-5B are an illustration of a probability for energy efficient generation of artificial noise to prevent side-channel attacks according to some non-limiting embodiments or aspects; and

FIG. 6 illustrates example components of a device used in connection with some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments or aspects as they are oriented in the drawing figures. However, it is to be understood that the embodiments or aspects may assume various alternative variations and step sequences, except where expressly specified to the contrary. It is also to be understood that the specific devices and processes illustrated in the attached drawings, and described in the following specification, are simply exemplary embodiments or aspects of the present disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or another original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or a standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, “public key encryption” involves encoding a message to protect it from unwanted viewers by passing the message through a mathematical function (called a “cipher”) which uses a key to hide the original values in the message, and decoding the message depends on having the key that returns the values back to their original state, allowing the message to be read. In public key encryption (e.g., asymmetric encryption), the key that encodes the message and the one that decodes it are different (i.e., asymmetrical). It's called public key, because one key is made widely available (the “public key”) while the other key is kept private (the “private key”) to ensure the security of the message. Public key encryption relies on private keys being kept secure, secret, and unavailable to those who would intercept, attack, or adulterate messages. Whether the public key is used to encrypt or verify the message depends on the nature of the message. For example, the private key is used to sign a message anyone can read, but cannot tamper with, at least without invalidating the signature. In cases where everyone is able to encrypt a message, but not open it (e.g., not able to be intercepted by the wrong person, etc.), it is encrypted with the public key, but only decrypted with the associated private key.

As used herein, “hashing” (e.g., a hash function) involves a method of cryptography that is designed to be irreversible. Hash functions are one-way algorithms, based on a mathematical function which takes an arbitrary input message and produces a deterministic output (e.g. a message digest). The one-way nature of the hash function means given the output, makes it difficult to determine the input that generated it. As used herein, hashing a message commonly serves one of two purposes, to protect the confidentiality of secret information (e.g. to validate the correctness of a password) or to confirm a message has been unmodified (e.g. to confirm the integrity of downloaded software). In the first case, when a message digest is created by hashing a message (e.g., a document, a number of data fields, etc.) for storage or transmission, in the event of an attack, all the hacker has stolen is unreadable, scrambled values (e.g., hash values, hash codes, digests, hashes, etc.). In the second case, message integrity can be determined by hashing a copy of the original message and comparing the result to the original message's digest value. One does not need to read the message itself to determine that the message has not been modified, just needs the output of hashing the message (e.g., message digest).

As used herein, satisfying a threshold may refer to a value (e.g., a score, a power consumption, etc.) being greater than the threshold, more than the threshold, higher than the threshold, greater than or equal to the threshold, less than the threshold, fewer than the threshold, lower than the threshold, less than or equal to the threshold, equal to the threshold, etc.

As used herein, a side-channel attack (SCA) may infer secret information (for example secret keys) by exploiting information that leaks from the implementation (such as power consumption). SCAs have been shown to be a non-negligible threat to modern cryptographic implementations and devices in recent years. Therefore, preventing SCAs on cryptographic devices have become an important problem. An SCA is a security exploit that attempts to extract extra information based on secrets related to how a chip, algorithm, or a system is implemented. An attack may be enabled by leakage of information from a physical cryptosystem. This can be achieved by measuring or analyzing various physical parameters (e.g., characteristics, etc.), such as, power, supply current, execution time/timing, electromagnetic emission, optical, or other hardware weaknesses. For example, an attacker may measure parameters (e.g., the electromagnetic radiation, radio waves, sounds, and/or the like produced by a target device) and then uses them to reconstruct the internal signals of that device. Characteristics that may be exploited in an SCA include timing, power consumption, electromagnetic, acoustic emissions, and/or the like.

One of the widely used countermeasures against SCAs is the injection of random noise sequences into the raw leakage traces. However, the indiscriminate injection of random noise can lead to significant increases in energy consumption in a device and alternatives must be found to reduce the amount of energy in noise generation while keeping the side-channel invisible. For example, an SCA which exploits physical information that leaks from the target devices to extract secret information (keys, password, etc.), have been shown to be successful in breaking a large number of cryptographic algorithms, implementations, or security in general over the years. The effectiveness of SCAs is based on the fact that physical information leakages are dependent on the internal state (secret) of the device. This dependency is often called leakage model or leakage function. There is a variety of forms of physical leakages, such as electromagnetic emanation, acoustic emanation, power consumption, or others. As the Internet of Things (IoT) and embedded devices in general are easily physically accessible, they are highly vulnerable to these forms of physical side-channel attacks.

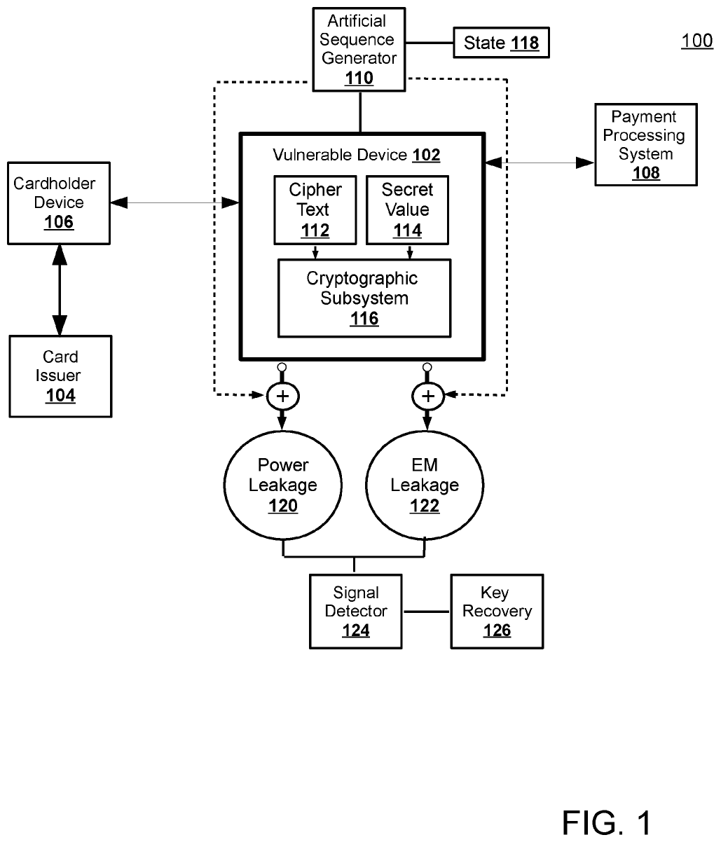

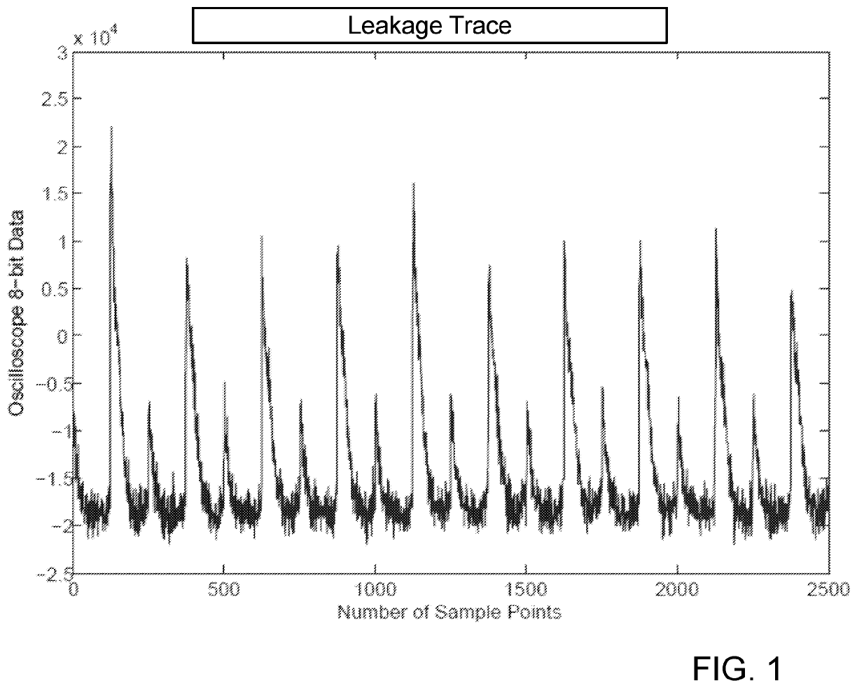

Power consumption analysis is a widely studied method for SCAs. By analyzing the power consumed by a particular device during a computation, attackers attempt to infer the secret inside the device. The inset graph in FIG. 1 shows an example of the power consumption, in some non-limiting embodiments or aspects, the current is drawn from an 8-bit micro-controller.

Fundamentally, SCAs can be distinguished as non-profiled and profiled attacks. In non-profiled side-channel attacks, the attacker leverages an a-priori assumption about the leakage model for extracting the secret. In power consumption based SCAs, there are two widely used models in non-profiled attacks: The Hamming Weight (HW) model, which assumes the power consumption depends on the number of “ones” in the secret, and the Hamming Distance (HD) model, which assumes that the power consumption depends on the number of bit flips between two consecutive internal states.

In profiled SCAs, the attacker first collects the leakage traces from the identical or from a similar device, and then learns the leakage model based on the collected data. This renders profiled SCAs to be data-driven approaches. There are two commonly used techniques in profiled attacks, which are the Template Attack and the Stochastic Model. In the Template Attack, the attacker builds for each secret key a separate model, which is called a template. The template typically is in form of Gaussian Model. During the attack, the attacker extracts the key by selecting that candidate key whose template best matches the leakage traces collected during the attacking phase. In the Stochastic Model, each time-sample point of the leakage trace is modeled as a linear combination of a secret (in binary string) and a coefficient vector, to which an independent noise is added. Hence, now profiling a leakage model is equivalent to estimating the coefficients at each time-sample point.

The effectiveness of SCAs is based on the physical leakage traces being dependent on the secret. Hence, breaking this dependency is an intuitive way to counter SCAs. For example, masking a secret is a technique which counters the attack directly at the algorithmic level of the cryptographic implementation. The principle of this technique is to randomly split the secret into multiple (for example d+1) shares, where any d shares cannot reveal the sensitive information. Given the leakage on each share, the bias of the secret decreases exponentially with the order of d. Recent research on code-based masking further enhances the side-channel security. However, although masking is shown to be an effective countermeasure to SCAs, it requires a complete re-design or reconstruction of the cryptographic implementation, such as the masked S-Box in AES Masking [14], which is quite invasive to the design process. The redesign of the algorithmic modules is costly and excludes the possibility of directly using current standard IP blocks.

Certain other techniques may prevent inferring a secret value via random noise generators to limit and/or cover the observable physical leakage (e.g., power consumption, electromagnetic emanation, etc.) emitted from cryptographic implementations or devices. However, random noise generation can incur a large overhead of energy consumption (e.g., for Advanced Encryption Standard (AES), overhead for random noise is at least 4 times the current output from a standard AES chip, etc.). Therefore, to have effectiveness in preventing attacks would require extreme amounts of additional power consumption.

In addition, using random noise may not accurately target a side channel. For example, random noise may not be designed to reduce (e.g., minimize) resource usage in a leakage prevention system. Additionally, optimization (e.g., minimizing, maximizing, etc.) of resource usage (e.g., power consumption, etc.) may be difficult while providing random noise-based masking of a side channel, since randomness is not optimized for power usage. As such, inefficiency and large amounts of computing resources and energy may result from providing random noise with no limits on the power consumption. Accordingly, side-channel leakage may not be sufficiently blocked or may be blocked inefficiently when providing only random noise to cover all leakage (e.g., against all leakage of the entire communication channel, etc.). The provided noise in such scenarios may not be properly calibrated (e.g., correlated, matched, etc.) to relevant portions of a signal of the communication channel (e.g., side channel) and instead may provide a universal blanket over all leakages with no limit (e.g., power limit, resource usage limit, etc.) regarding random noise.

Random noise generation based counter measures do not work directly on the core architecture of the cryptographic implementation. Typically, the generation of the noise sequences is independent to the cryptographic operations. By superposing the random noises on the raw leakage traces, the signal to noise ratio (SNR) of the leakage signal received by the attacker is decreased, which eventually hides the power consumption leakage of the secret-dependent operation. However, this technique may not provide energy efficient noise, as it incurs a large overhead (i.e., nearly 4 times the AES current consumption) in order to obtain a high resistance to a correlation power analysis (CPA) based attack. However, in some non-limiting embodiments or aspects, this energy consumption can be reduced to only a few samples in leakage traces that contain useful information that relate to the secret in the target device. For example, embedding protection on the voltage regulator may be used to degrade the SNR of the power traces used to attack. However, one of the limitations is that they both indiscriminately compensate the entire large power signal, and thereby create costly energy consumption to defend against the SCAs as the random noise generation.

Therefore, an optimal energy efficient design for artificial noise generation to prevent SCAs is provided herein. This approach exploits the sparsity among the leakage traces to model a side-channel as a communication channel, which allows use of channel capacity to measure the mutual information between the secret and the leakage traces. For a given energy budget in the noise generation, to obtain the optimal design of the artificial noise injection, the side-channel's channel capacity minimization problem is solved. In some non-limiting embodiments or aspects, the experimental results also validate the effectiveness of the embodiment.

Provided herein are improved systems, methods, and computer program products for energy efficient generation of artificial noise to prevent SCAs. In some non-limiting embodiments or aspects, an artificial sequence generator may provide safety protection using the system, method, and/or computer program products in this application, to provide protection to a cryptographic subsystem (e.g., cryptographic circuit) vulnerable to an SCA. For example, according to the systems, methods, and computer program products described herein, an artificial sequence generator may receive, obtain, and/or store a state indication associated with a device/cryptographic subsystem based on the device/cryptographic subsystem previously executing a cryptographic operation, or previously executing a number of cryptographic operations, based on a secret value, and the artificial sequence generator may efficiently generate a plurality of samples of artificial noise for overlaying on portions of a side channel signal, such that the samples of artificial noise are targeted to mask leakage information on the side channel signal associated with the secret value, thereby providing improved security/safety and preventing an SCA (e.g., by making such attack infeasible) while preserving power and computing resources (e.g., by only masking the portions of the side channel signal associated with the secret value rather than masking the entire side channel signal with random noise). In this way, side channel attacks may be stopped (or reduced) by generating an optimized sequence of samples of artificial noise, which can be inserted into/overlaid onto one or more positions of the side channel signal to change leakage traces to make usage thereof infeasible, or impossible, and thereby more efficiently preventing or protecting from SCAs on target devices. Further technical improvements are provided for generating an energy efficient artificial noise sequence that is optimized to mask power leakage traces in order to frustrate one or more SCAs from attacker's side. For example, an artificial sequence generator may generate the samples of artificial noise based on power constraint parameters (e.g., a rank parameter for a selection matrix and/or a signal constraint parameter, which may have a direct current (DC) component and/or an alternating current (AC) component) to provide for more efficiently indicating an amount of samples for the artificial sequence generator to generate. In this way, it is possible to safely operate a cryptographic subsystem in a remote location, with limited protection, while eliminating a risk of attackers gathering leakage traces that can be used to attack a cryptographic system (e.g., by discovering the secret values from the leakage traces).

Referring now to FIG. 1, FIG. 1 is a diagram of an example system 100 for energy efficient generation of artificial noise to prevent SCAs, according to some non-limiting embodiments or aspects. As shown in FIG. 1, system 100 includes vulnerable device 102, issuer system 104, cardholder device 106, and payment processing system 108.

Issuer system 104 may include one or more devices capable of receiving information and/or communicating information to cardholder device 106, vulnerable device 102 (e.g., via cardholder device 106), and/or payment processing system 108 (e.g., via a communication network). For example, issuer system 104 may include a computing device, such as a server, a group of servers, and/or other like devices. In some non-limiting embodiments or aspects, issuer system 104 may be associated with an issuer institution. For example, issuer system 104 may be associated with an issuer institution that issued a credit account, a debit account, a credit card, a debit card, and/or the like to a user associated with a card holder.

Cardholder device 106 may include one or more devices capable of receiving information from and/or communicating information to vulnerable device 102, issuer system 104, and/or payment processing system 108 (e.g., via a communication network). Additionally or alternatively, each cardholder device 106 may include a device capable of receiving information from and/or communicating information to other cardholder devices 106 via a communication network, or another network (e.g., an ad hoc network, a local network, a private network, a virtual private network, and/or the like), and/or any other suitable communication technique. For example, cardholder device 106 may include a client device and/or the like. In some non-limiting embodiments or aspects, cardholder device 106 may or may not be capable of receiving information (e.g., from vulnerable device 102 of a merchant system or from another cardholder device 106) via a short-range wireless communication connection (e.g., a near field communication (NFC) connection, a radio-frequency identification (RFID) communication connection, a Bluetooth® communication connection, a Zigbee® communication connection, and/or the like), and/or communicating information (e.g., to a merchant system) via a short-range wireless communication connection.

Vulnerable device 102 may include one or more devices capable of receiving information from and/or communicating information to transaction service provider system, issuer system 104, cardholder device 106, and/or payment processing system 108. Vulnerable device 102 may also include a device capable of receiving information from cardholder device 106 via a communication connection (e.g., an NFC communication connection, an RFID communication connection, a Bluetooth® communication connection, a Zigbee® communication connection, and/or the like) with cardholder device 106, and/or the like, and/or communicating information to cardholder device 106 via the communication connection, and/or the like. In some non-limiting embodiments or aspects, vulnerable device 102 may include a computing device, such as a server, a client device, and/or other like devices. In some non-limiting embodiments or aspects, vulnerable device 102 may be associated with a merchant. In some non-limiting embodiments or aspects, vulnerable device 102 may include one or more client devices. For example, vulnerable device 102 may include a client device that allows a merchant to communicate information to payment processing system 108 (e.g., a transaction service provider system and/or the like). In some non-limiting embodiments or aspects, vulnerable device 102 may include one or more devices, such as computers, computer systems, and/or peripheral devices capable of being used by a merchant to conduct a transaction with a user. For example, vulnerable device 102 may include a point of sale (POS) device and/or a POS system. In some non-limiting embodiments or aspects, vulnerable device 102 may include a card reader, which may be connected to cardholder device 106. In some non-limiting embodiments or aspects, vulnerable device 102 may include an IoT device, such as a smart appliance, an intelligent assistant, and/or the like. In some non-limiting embodiments or aspects, vulnerable device 102 may be the same as or part of cardholder device 106.

Payment processing system 108 may include one or more devices capable of receiving information from and/or communicating information to vulnerable device 102, issuer system 104, or cardholder device 106 (e.g., via a communication network). For example, payment processing system 108 may include a computing device, a server, a group of servers, and/or the like. In some non-limiting embodiments or aspects, payment processing system 108 may be associated with a transaction service provider (e.g., a transaction service provider system), an acquirer (e.g., an acquirer system), a payment gateway (e.g., a payment gateway system), any combination thereof, and/or the like, as described herein.

With continuing reference to FIG. 1, vulnerable device 102 may include and/or be connected to artificial sequence generator 110. For example, artificial sequence generator 110 may include a computing device and/or the like capable of storing a state indicator and generating artificial noise sequences (e.g., a plurality of samples of artificial noise and/or the like).

In some non-limiting embodiments or aspects, vulnerable device 102 may store (and/or receive from cardholder device 106 or payment processing system 108) a secret value, which may include secret value bits. For example, vulnerable device 102 may store (and/or receive) cipher text 112 and/or a secret value 114 (e.g., a secret key, such as a private cryptographic key). For the purpose of illustration, vulnerable device 102 may store cipher text 112 and/or secret value 114 to use with cardholder device 106 and/or payment processing system 108, e.g., to initiate a payment transaction. In some non-limiting embodiments or aspects, when the cipher text 112 and/or secret value 114 are processed by cryptographic subsystem 116, such processing may be in concert with artificial sequence generator 110 (e.g., artificial noise generator, etc.) so that leakage information associated with cipher text 112 and/or secret value 114 on a side channel signal (e.g., power signal, electromagnetic signal, and/or the like) may be masked, thereby preventing an SCA.

In some non-limiting embodiments or aspects, artificial sequence generator 110 may receive state information 118 related to vulnerable device 102. For example, state information 118 may be previously generated and/or learned during previous cryptographic operations executed by cryptographic subsystem 116, such as previous cryptographic operations executed for the purpose of detecting state information 118, and state information 118 may include an indication of the state of cryptographic subsystem 116 with respect to executing a cryptographic operation with cipher text 112 and/or secret value 114 (e.g., an indication that the cryptographic operation is starting and/or ongoing). State information 118 may be used by artificial sequence generator 110 to determine when to generate artificial noise (e.g., samples of artificial noise) to act as a countermeasure to protect the vulnerable cryptosystem from side channel leakage only during processing of the secret information (e.g., cipher text 112 and/or secret value 114), rather than constantly generating random noise, which would waste power and resources.

In some non-limiting embodiments or aspects, a state indicator, or pattern, may include information that is related to a feature (e.g., sparsity) of the raw leakage traces that are emitted from a device executing cryptographic operations. Such a feature is device related (e.g., device specialized), and may indicate a location of points in an operation where useful information may be located. In some examples, the state indicator identifies a feature which operates to determine all secret values used by a device because the leakage information emitted while executing such information related to one or more secret keys comprises the same pattern since the secret keys are all stored and manipulated by the same device.

In some non-limiting embodiments or aspects, artificial sequence generator 110 may be configured to counteract SCAs by rouge operators. As an example, artificial sequence generator 110 may counteract SCAs that gather leakage data of cryptographic subsystem 116 using sensors (e.g., power sensors, voltage sensors, electromagnetic sensors, timing sensors, sound detectors, etc.) or other techniques to measure parameters of vulnerable device 102 and/or cryptographic subsystem 116 (e.g., power or voltage leaks, electromagnetic leaks, timing information, sound leaks, etc.) that can provide an extra source of information for attackers to exploit. Such information about vulnerable device 102 and/or cryptographic subsystem 116 thereof may be used by attackers with sophisticated and powerful tools for inferring knowledge about secret value 114 or cipher text 112. For example, power consumption may be used to discover information about power leakage 120. In another example, electromagnetic signals may be used to discover information about electromagnetic leakage 122.

As shown, cryptographic subsystem 116, cipher text 112, and/or secret value 114 may be protected and processed inside tamper-resistant hardware of vulnerable device 102. However, if an attacker has access to or can monitor a side channel, such as with signal detector 124, the attacker may be able to compromise vulnerable device 102 and/or cryptographic subsystem 116 thereof by discovering the secret values with key recovery system 126. For example, to implement an attack, physical access to a pair of identical devices (e.g., the profiling device and the attacked device) may be used to infer a secret value that is processed by the attacked device at some point. In such an example, the profiling device is used to identify templates, wherein each of the template of the profiling device may be associated with the same secret value or a different secret value.

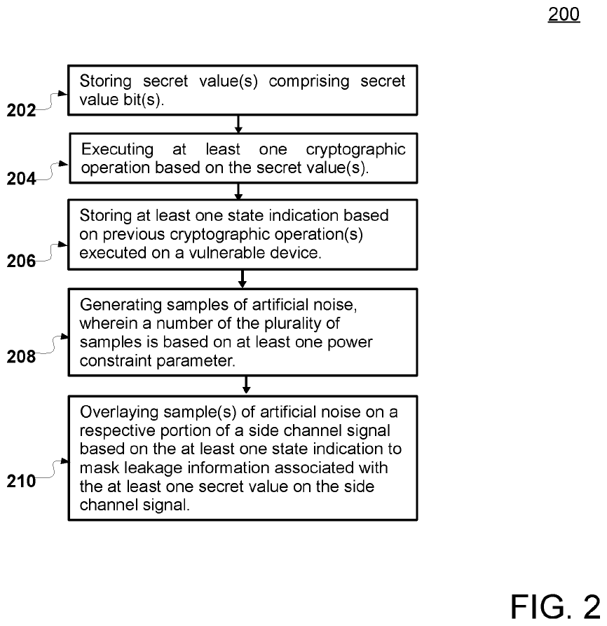

Referring now to FIG. 2, FIG. 2 is a flowchart of an example process 200 for energy efficient generation of artificial noise to prevent SCAs according to some non-limiting embodiments or aspects. In some non-limiting embodiments or aspects, one or more of the steps of process 200 may be performed (e.g., completely, partially, and/or the like) by vulnerable device 102 (e.g., one or more devices of vulnerable device 102) and/or artificial sequence generator 110 (e.g., one or more devices of artificial sequence generator 110). In some non-limiting embodiments or aspects, one or more of the steps of process 200 may be performed (e.g., completely, partially, and/or the like) by another system, another device, another group of systems, or another group of devices, separate from or including the aforementioned devices, such as issuer system 104, cardholder device 106, and/or payment processing system 108.

As shown in FIG. 2, at step 202, process 200 may include storing secret value(s) comprising secret value bit(s). For example, in some non-limiting embodiments or aspects, vulnerable device 102 stores at least one secret value comprising secret value bits.

In some non-limiting embodiments or aspects, vulnerable device 102 (e.g., target device, etc.) stores at least one secret value comprising secret value bits that may be exploited during SCAs, and may include physical information that leaks from vulnerable device 102 in the form of secret information (e.g., keys, passwords, etc.). In such an example, vulnerable device 102 (e.g., target device, etc.) may be exploited via an SCA attempting to determine the at least one secret value (e.g., the secret value bits, etc.) for breaking a large number of cryptographic algorithms, implementations, or security based on physical information leakages that include information about the internal state of vulnerable device 102.

In some non-limiting embodiments or aspects, there may be a variety of forms of physical leakages. However, by analyzing the power consumed by vulnerable device 102 during a computation, attackers attempt to infer the secret inside vulnerable device 102.

In some non-limiting embodiments or aspects, vulnerable device 102 protects at least one secret value comprising secret value bits by an energy efficient scheme to generate artificial noise sequences preventing SCAs on devices. For example, by generating and/or mapping an SCA model to a communication model to measure the mutual information between the side-channel leakage and the secret.

In some non-limiting embodiments or aspects, vulnerable device 102 protects at least one secret value based on the sparsity of the raw leakage traces, such that vulnerable device 102 determines and protects only one or more leakage samples which contain useful leakage information, such as leakage information that can be used to determine the secret value bits of the leakage samples.

In some non-limiting embodiments or aspects, vulnerable device 102 protects at least one secret value by generating an optimal noise sequence under a given energy constraint.

In some non-limiting embodiments or aspects, vulnerable device 102 protects at least one secret value by generating synchronous noise or asynchronous noise while compensating for a delay introduced by hardware when generating noise sequence (e.g., that may not be exactly matched with the leakage trace, etc.).

In some non-limiting embodiments or aspects, vulnerable device 102 protects at least one secret value against an attacker that measures the power consumption electromagnetic radiation, radio waves, hardware waves, supply current, execution time, and/or the like, given off by a target device to reconstruct the internal signals of that device. Vulnerable device 102 prevents modern SCAs by hiding (e.g., obfuscating, shielding, overlaying, etc.) the cryptographic operations of a system to prevent an attack which measures and derives secret keys achieved by measuring or analyzing various physical parameters of vulnerable device 102. In such an example, vulnerable device 102 prevents a measurement of the power consumption of a device or a subsystem (e.g., prevents measurement of an amount and timing of power used by a system or one of its subcomponents).

As shown in FIG. 2, at step 204, process 200 may include executing at least one cryptographic operation based on the secret value(s). For example, in some non-limiting embodiments or aspects, vulnerable device 102 executes at least one cryptographic operation based on the at least one secret value. In some examples, cryptographic subsystem 116 of vulnerable device 102 executes at least one cryptographic operation based on the at least one secret value.

In some non-limiting embodiments or aspects, cryptographic subsystem 116 or vulnerable device 102 executes cryptographic tools and techniques used to protect communication and information exchange for confidentiality, non-repudiation, integrity, and authenticity. Modern cryptographic techniques involve converting plain-text messages into cipher text, such that the intended recipient can only decode.

In some non-limiting embodiments or aspects, cryptographic subsystem 116 of vulnerable device 102 executes at least one cryptographic operation based on the at least one secret value(s) to protect against an application security vulnerability that exposes sensitive application data, comprising passwords, patient health records, business secrets, credit card information, email addresses, personal information, and/or the like.

As shown in FIG. 2, at step 206, process 200 may include storing at least one state indication (e.g., in an artificial sequence generator) based on previous cryptographic operation(s) executed on a vulnerable device. For example, in some non-limiting embodiments or aspects, artificial sequence generator 110 (e.g., artificial noise generator, etc.) stores at least one state indication based on a plurality of previous cryptographic operations executed on the device. In such an example, artificial sequence generator 110 may generate noise samples to overlay or add to a leakage trace while any secret value is executed.

In some non-limiting embodiments or aspects, a state indication is learned by a device other than artificial sequence generator 110, and then the state indication is communicated to and/or embedded within artificial noise generator 110 (e.g., stored and sealed into artificial sequence generator 110, etc.). For example, one or more other devices may be used to measure raw leakage traces, such as traces from vulnerable device 102 without any noise generator attached. The state of the traces of this device may then be obtained through one or more algorithms. In this way, when any secret value is used during execution of cryptographic operations on the device, artificial sequence generator 110 may generate noise samples based on information related to the state of vulnerable device 102.

In some non-limiting embodiments or aspects, artificial sequence generator 110 maps a SCAs model to communication models. In some non-limiting embodiments or aspects, a general uniform framework is proposed to integrate SCAs and classic communication theory. Under this framework, the effect of the modeled leakage function can be quantified by viewing the side-channel as a noisy channel in communication theory. In such an example, a number of optimal side-channel distinguishers for different scenarios model the side-channel as a fading channel. As a result, the profiling problem in SCAs can be formulated as a channel estimation problem in communication systems.

In some non-limiting embodiments or aspects, the side-channel model can be modeled as: L=Y(X)+N, such that L∈ [symbol] ^{m+1} is the leakage trace, X is the internal state (secret) in the implementation, Y(X) [symbol] ^{m*1} is the deterministic part of the side channel leakage (e.g., dependent on X), and N∈ [symbol] ^{m∈×1} is the random part and typically is modeled as an independent and identically distributed Gaussian noise vector with distribution [symbol] (μN,ΣN).

Typically, there are two widely used models to represent the side-channel leakage in non-profiled and profiled SCAs, respectively. As an example, non-profiled attacks may include an attacker that only has access to a closed target device of which the key cannot be changed. As another example, profiled attacks may include the attacker that has access to an open copy of the target device of which the key can be changed and which is used to characterize the leakage of the device prior to the attack.

In some non-limiting embodiments or aspects, a Hamming Weight Model protects for non-profiled side-channel attacks, the side-channel leakage is assumed to follow an HW model, which is represented by: L=HW(X)+N, where HW(X)+N is the HW function. A special case of HW model is the HD model, where the power leakage is dependent on the HD function of the internal state, which is the result of XOR operation between the states before and after the cryptographic operations.

In some non-limiting embodiments or aspects, a Linear Model: Previous work, especially the Stochastic Model, has shown that the side channel can be linearly represented. For example, the binary string vector of the secret X is F_{b}(X)∈R^{(B+)*1}, where B is the number of the bits, bitb(X) is defined as the b-th bit value of the binary string (typically bit0(X)=1 is assumed), and W∈R^{m*(B+1)} is the leakage coefficients matrix where each element wij is the weight coefficient at sample point i for the leakage caused by bit j+1, and there is a linear relationship between L and X:L=WF_{b}(X)+N. The Linear model is typically used in profiled SCAs, where the leakage matrix (model) W is built in the profiling phase and used in the attack phase.

Generally, beyond which type of leakage model is applied, mutual information provides a common metric to measure how much information of secret X is contained in the leakage trace L. Mutual information is defined as: I(L;X)=H(X)−H(X|L), where H(X) is the entropy of X and H(X|L) is the conditional entropy of X based on L.

The maximum mutual information leaked through a side-channel (e.g., a channel capacity, etc.) is expressed as:=max I(L;X). In such an example, a person of ordinary skill in the art would understand that the SCA model differs from the classical communication model, such that in the SCA the leakage trace is measured (e.g., received, etc.) by the attacker. For example, rather than acting as the receiver, the attacker is in the role of the eavesdropper, similar to the channel in the communication model. Hence, the attacker may not influence the input (the target secret X) in the target implementation (transmitter) through the communications between the transmitter and the attacker as in the communication model, and therefore may not optimize the channel capacity of the side-channel.

In some non-limiting embodiments or aspects, artificial sequence generator 110 constructs the side-channel's channel capacity. For example, artificial sequence generator 110 models the leakages as multi-input multi-output (MIMO) channels. However, the modeling (e.g., constructing the side-channel's channel capacity by modeling the leakages as MIMO) channels, etc.) of side-channel leakages is not limited to the linear model. In other examples, a variety of non-linear models have been proposed and fully studied, such as convolutional neural networks and the quadratic model. According to some non-limiting embodiments or aspects, artificial sequence generator 110 constructs a general model to characterize the side-channel of vulnerable device 102, such that the side-channel is an additive noisy channel, as shown in L=Y(X)+N. In such an example, the channel capacity of the side-channel is expressed by channel capacity formula:

$$C = \frac{1}{2} log ( 1 + SNR ) = \frac{1}{2} log ( 1 + \frac{{\vert Y ( X ) \vert}^{2}}{E [ {\vert N \vert}^{2} ]} ) ,$$

where E(·) is the expectation function, and SNR is the signal-to-noise ratio of the leakage signal received by attacker. The channel capacity formula can be easily applied to all forms of leakage models, such as HW or HD model, the linear model, and any non-linear models, given that Y (X) is the side-channel leakage function part.

In some non-limiting embodiments or aspects, artificial sequence generator 110 generates noise sequence to counter SCAs. For example, as shown in the channel capacity formula, the mutual information between the secret X and the leakage trace L is determined by the SNR of the received leakage signals. Hence, from the view of the traditional communication theory, mitigating the power of the SCAs is equivalent to reducing the SNR of the leakage signals received by the attacker. In communication model, one way to achieve this SNR reduction is to inject random noise into the transmitted signal. As a result, the SNR of the signal received by the eavesdropper is decreased, which eventually degrades (e.g., jams, blocks, etc.) the eavesdropper's channel, as this is the basis for jamming. Similarly, in other examples of SCAs, injecting random noise on original leakage traces is a practical way to counter SCAs.

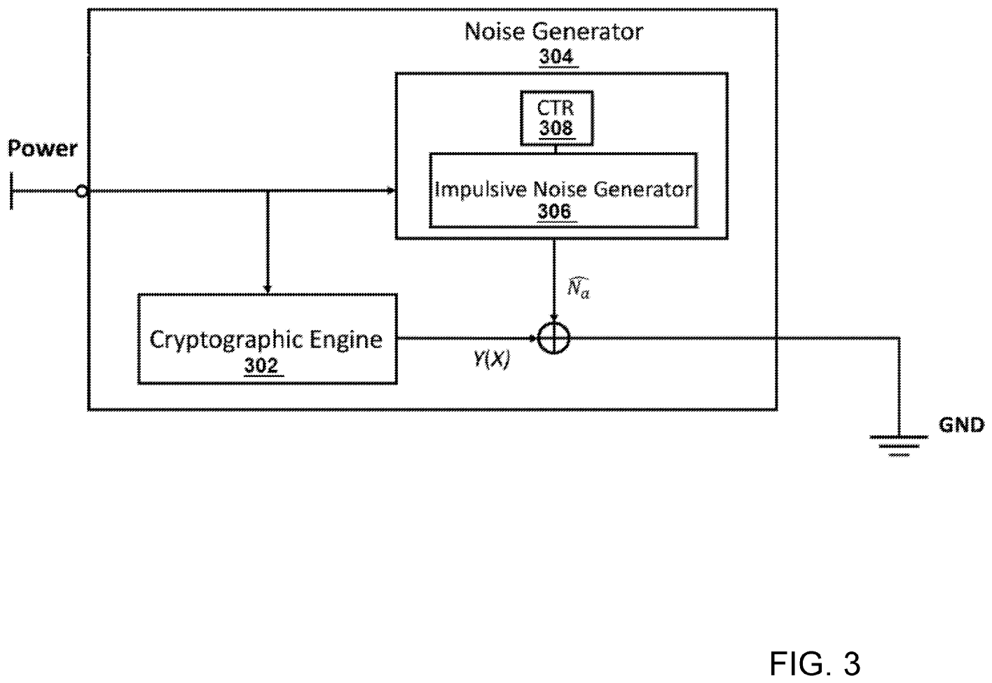

With reference to FIG. 3, an example artificial noise generator system 300 is illustrated for energy efficient generation of artificial noise to prevent SCAs, according to some non-limiting embodiments or aspects. In some non-limiting embodiments or aspects, artificial noise generator system 300 may include power (e.g., current, etc.) that flows from the input (POWER) to the ground (GND). Artificial noise generator system 300 further includes cryptographic engine 302 and embedded noise generator 304 to perform the cryptographic operations, such as a crypto engine (e.g., public-key encryption from any standard public-key encryption, pseudorandom functions, symmetric-key encryption, message-authentication codes, AES, Data Encryption Standard (DES), or Rivest-Shamir-Adleman (RSA) in an IoT device, and/or the like. The noise sequence is independently and randomly generated from noise generator 304. The noise sequence that is emitted from the engine during the computation is then injected into the raw leakage trace based on a state of the leakage. In some non-limiting embodiments or aspects, the generation pattern may be represented by a state-transition probability matrix, stored and triggered in control module (CTR) 308 of impulsive noise generator 306. In some non-limiting embodiments or aspects, one or more of the steps of process 200 may be performed (e.g., completely, partially, and/or the like) by artificial noise generator system 300 (e.g., one or more devices of artificial noise generator system 300, artificial sequence generator 110, etc.) and/or cryptographic engine 302 (e.g., one or more devices of cryptographic engine 302, one or more devices of vulnerable device 102, cryptographic engine subsystem 116, etc.). In some non-limiting embodiments or aspects, one or more of the steps of process 200 may be performed (e.g., completely, partially, and/or the like) by another system, another device, another group of systems, or another group of devices, separate from or including the aforementioned devices, such as issuer system 104, cardholder device 106, and/or payment processing system 108.

As a result, the raw leakage trace and the random noise sequence are mixed together, which results in a “new” leakage trace that the attacker only can measure. Generally, the leakage traces superposed by the random noise can be expressed as: L=Y(X)+N+Nᵣ, where Nr is the independent and identically distributed random noise vector, with a distribution N (μr, Σr). In such an example, the capacity of the side-channel becomes:

$$C = \frac{1}{2} log ( 1 + SNR ) = \frac{1}{2} log ( 1 + \frac{{\vert Y ( X ) \vert}^{2}}{E [ {\vert {N}_{r} \vert}^{2} ] + E [ {\vert N \vert}^{2} ]} ) , .$$

Compared to the channel capacity equation, the addition of the term E[|Nᵣ|²] in the denominator decreases the SNR in the equation above, as well as the channel capacity. While the random noise generation method hides the cryptographic operations, such a configuration leads to significant energy consumption and to get a high enough resistance to SCAs (e.g., in the AES, etc.), the current consumption is increased by a factor of four. This motivates the need to design an energy efficient and also powerful noise generation scheme to counter SCAs.

In some non-limiting embodiments or aspects, artificial sequence generator 110 may compress the leakage data during the profiling and the attack phases. For example, often only very few leakage samples of the raw leakage traces contain useful leakage information (e.g., the leakage traces are sparse, scattered, etc.). In such an example, sparsity is caused by the fact that many other activities in the implementation of the cryptographic system that are not dependent on the secret, such as, due to fixed 1/O (Input/Output) activities. Thus, in order to perform an efficient attack, in some examples, one may compress the collected leakage traces and then extract the useful leakage information. A widely used method to compress the large amount of data is the so-called sampling selection technique when selecting a subset from all recorded leakage samples, allowing the number of samples to be compressed by reducing to a feasible level (e.g., a feasible number of samples to work with, etc.). A variety of methods to select the samples may include at least one of a difference of means (e.g., a difference of means (DOM) which includes 1 ppc, 3 ppc, 20 ppc, and allap), a sum of squared pairwise t-differences (SOST), or an SNR.

Generally, the data compression process can be represented as: PL=PY(X)+PN, where P∈ [symbol] ^{m}^{_{c}}^{*m} with [symbol] _{c}<< [symbol] as the compression matrix. In the case of sampling selection, the compression matrix is also called the sampling matrix. Each row in P has at most one “1”, and the index of the “1” in each column of P stands for which sample in the leakage signal Y (X) is to be picked (e.g., the sampling matrix is a permutation matrix with additional zero columns, etc.). For example, when considering a sampling process where only the 1st, 2nd, and the last leakage samples are picked (i.e., now mc=3), P may be expressed by

$$P = [ \begin{matrix}1 & 0 & 0 & … & 0 \\ 0 & 1 & 0 & … & 0 \\ 0 & 0 & 0 & … & 1\end{matrix} ] .$$

However, once the sampling method is chosen, P is defined.

With continued reference to FIG. 2, at step 208, process 200 may include generating samples of artificial noise, wherein a number of the plurality of samples is based on at least one power constraint parameter. For example, in some non-limiting embodiments or aspects, artificial sequence generator 110 generates a plurality of samples of artificial noise, wherein a number of the plurality of samples is based on at least one power constraint parameter.

In some non-limiting embodiments or aspects, artificial sequence generator 110 generates a plurality of samples of artificial noise, wherein a number of the plurality of samples is artificial noise generated from at least one power constraint parameter.

For example, artificial sequence generator 110 generates a plurality of samples of artificial noise based on a scheme to prevent SCAs by designing artificial noise sequences which are superposed onto a raw leakage trace. With continued reference to FIG. 3, the artificial noise generator shown may determine the observed leakage trace can therefore be represented as: \hat{L}=Y(X)+N+ [symbol] . The term [symbol] is the artificial noise generated from the designed noise generator, which is defined as: [symbol] =pFNₐ, where p is the gain factor, and Nₐ is independent and identically distributed Gaussian distributed [symbol] noise with the distribution [symbol] (μₐ,Σₐ).

In some non-limiting embodiments or aspects, the covariance Σₐ is a diagonal matrix with identical value σₐ in the diagonal. In this example, Nₐ is the noise source of the impulsive noise generator, and p is the gain on the amplitude of the generated impulsive noise. As explained above, the random noise generation may not be energy efficient as it generates noises to corrupt all leakage samples. Besides, as explained above, typically only a subset of leakage samples contain secret-dependent useful information. Hence, the designed noise sequence which aims at only corrupting those useful samples is in fact an impulsive noise sequence. Moreover, with continued reference to FIG. 3, the noise generator, as shown, can directly apply the majority modules in the traditional impulsive noise generator, but only makes the change on the modeling of the inter-arrival times of the generated noise sequence. This is different to the traditional impulsive noise generator, where the inter-arrival times of the impulsive noise is modeled as a Markov renewal process (MRP) and hence the inter-arrival time between two consecutive impulses is random (controlled by a Markov state-transition probability matrix), the inter-arrival times of the impulse noise in the noise generator (artificial sequence generator 110) is pre-defined. More specifically, by artificially controlling the generation of the impulsive noise, artificial sequence generator 110 may generate an impulsive noise sequence with a predictive pattern to determine where the impulses appeared. The inter-arrival times between those impulses are therefore defined. In some non-limiting embodiments or aspects, the generation pattern may be represented by a state-transition probability matrix, stored and triggered in CTR 308 of impulsive noise generator 306. The transition matrix is expressed by:

$$G = [ \begin{matrix}{β}_{1 , 1} & {β}_{1 , 2} & … & {β}_{1 , n} \\ {β}_{2 , 1} & {β}_{2 , 2} & ⋮ & {β}_{2 , n} \\ ⋮ & ⋮ & ⋱ & ⋮ \\ {β}_{n , 1} & {β}_{n , 2} & … & {β}_{n , n}\end{matrix} ] ,$$

where n is the total number of states in the impulsive noise sequence generation, ρ_{i,j} is the transition probability from state sᵢ to sⱼ, and the state sᵢ represents where the i-th impulse event should occur in the sequence given the first i impulses are pre-defined. In this example n equals the maximum number of the impulses that may be generated in a duration. In some non-limiting embodiments or aspects, the generation of the impulsive noise sequence is pre-defined in the design, so that β_{i,j}=1 only if sᵢ matches with the first i impulses in sⱼ (sᵢ=sⱼ₋₁), and β_{i,j}=0 for the rest of the cases. In this case, G is in fact a sparse matrix since the majority of the elements in G is 0.

In some non-limiting embodiments or aspects, the design of the transition matrix may be mapped to a process of impulsive noise samples selection. For example, selection of the generation of the impulsive noises (e.g., a set of instructions to trigger the impulsive generation, not trigger the impulsive generator, etc.) is represented by the diagonal matrix∈R^{m*m}, which injects the impulsive noises into a subset of samples of the original leakage trace Y (X). Values on the diagonal can be “0” or “1”, and the positions of the “1”s in the diagonal determines which artificial noise samples will be generated and injected into the leakage trace (i.e., for which samples in the leakage trace are injected with impulsive noises). As an example, if the impulsive samples are generated and injected into only the beginning and the end points of a leakage trace, then F would be:

$$F = [ \begin{matrix}1 & 0 & … & 0 \\ 0 & 0 & … & 0 \\ ⋮ & ⋮ & ⋱ & ⋮ \\ 0 & 0 & … & 1\end{matrix} ] , .$$

In contrast to an indiscriminate random noise generation approach, in some non-limiting embodiments or aspects, impulsive noise generator 306 of noise generator 304 may generate a noise generator model to exploit the sparsity in the leakage trace so that the number of useful leakage samples is small and only a small number of noise samples are generated to inject into the raw leakage trace, such that a more energy-efficient scheme generates a noise sequence for countering SCAs.

In some non-limiting embodiments or aspects, given an original device which may not have any noise generator attached, the system initiates by measuring the raw leakage traces that are emitted from cryptographic engine 302. Then, based on a pre-defined sampling method P, the designer extracts a subset of samples from the raw leakage trace and obtains the parameters that are related to these leakage samples. In some examples, one or more device hardware related parameters may include the mean, the variance, the duration, the spectra, and/or the like. The parameters may be used to construct the basic modules of impulsive noise generator 306. In such an example, based on the sampling method P and other system design requirements (e.g., the energy constraint on noise generation, etc.), the designer constructs a selective process F for generating the impulsive noise sequence, and F will be mapped to construct the state-transition matrix G. As a result, G will be stored as fixed parameters into CTR 308. Finally, once noise generator 302 is constructed, it may be sealed into the system, attached with cryptographic engine 302. In such an example, it may be determined how to design F in order to generate the optimal energy-efficient artificial noise sequence.

With continued reference to FIG. 2, at step 210, process 200 may include overlaying sample(s) of artificial noise on a respective portion of a side channel signal based on the at least one state indication to mask leakage information associated with the at least one secret value on the side channel signal. For example, in some non-limiting embodiments or aspects, artificial sequence generator 110 overlays each sample of artificial noise of the plurality of samples of artificial noise on a respective portion of a side channel signal based on the at least one state indication to mask leakage information associated with the at least one secret value on the side channel signal.

In some non-limiting embodiments or aspects, artificial sequence generator 110 overlays each sample of artificial noise of the plurality of samples of artificial noise on a respective portion of a side channel signal based on the at least one state indication to mask leakage information associated with the at least one secret value on the side channel signal by first optimizing the artificial noise generation. For example, if the leakage trace is perturbed by an artificial noise sequence Nₐ, and the sample selection sampling matrix P is determined, then after the data compression, the collected leakage trace can be expressed by:

$$P \hat{L} = PY ( X ) + PN + {PpFN}_{a} ,$$

Here, Nₚ=PN. Thus, the SNR of the compressed observed leakage trace is:

$$SNR = \frac{{\vert PY ( X ) \vert}^{2}}{{p}^{2} E [ {\vert {PFN}_{a} \vert}^{2} ] + E [ {\vert {N}_{P} \vert}^{2} ]} ,$$

$$E [ {\vert {PFN}_{a} \vert}^{2} ] = E [ {N}_{a}^{T} {F}^{T} {P}^{T} {PFN}_{a} ] = E [ {N}_{a}^{T} {F}^{T} \hat{P} {FN}_{a} ] ,$$

where the notation “(·)^{T}” denotes the matrix transpose operation.

Continuing the example, let \hat{P}=PT P, where \hat{P}∈ [symbol] ^{m*m} is a diagonal matrix with “0”s and “1”s on the diagonal. The index of each “1” on the diagonal exactly matches with the index of the “1” in each column of P. Continuing, if

$$P = [ \begin{matrix}1 & 0 & 0 & … & 0 \\ 0 & 1 & 0 & … & 0 \\ 0 & 0 & 0 & … & 1\end{matrix} ] ,$$

then as an example, \hat{P} is:

$$\hat{P} = [ \begin{matrix}1 & 0 & … & 0 \\ 0 & 0 & … & 0 \\ ⋮ & ⋮ & ⋱ & ⋮ \\ 0 & 0 & … & 1\end{matrix} ] ,$$

then Δ=F_{T}\hat{P}F, based on the matrix trace operation, so that:

$$E [ {\vert {PFN}_{a} \vert}^{2} ] = E [ Tr ( {N}_{a}^{T} ) ] = Tr ( E [ Δ {NaN}_{a}^{T} ] ) ,$$

and as a result, the channel capacity of the side-channel becomes:

$${C}_{s} = \frac{1}{2} log ( 1 + \frac{{\vert PY ( X ) \vert}^{2}}{{p}^{2} Tr [ E \vert Δ {NaN}_{a}^{T} \vert ] + E [ {\vert {N}_{P} \vert}^{2} ]} ) .$$

From the channel capacity of the side-channel equation above, it can be shown, for a predefined sampling method P, and a target secret X in the target implementation, the energy of the received compressed signal, |PY(X)|², is fixed. Since N is specified by the machine, E[Nₚ²] is also fixed for a given implementation device. In such an example, in order to maximize the effectiveness in securing the target implementation from SCAs, the objective is to minimize the channel capacity Cₛ above by appropriately designing the artificial noise [symbol] . This design may occur in a way that minimizes the energy spent generating the noise sequence.

In some non-limiting embodiments or aspects, as shown:

$$E [ {\vert {PFN}_{a} \vert}^{2} ] = E [ Tr ( {N}_{a}^{T} ) ] = Tr ( E [ Δ {NaN}_{a}^{T} ] ) ,$$

and in order to guarantee the confidentiality of a secret communication, the artificial noise (e.g., generated by artificial sequence generator 110) may be designed to maximally degrade the eavesdropper's channel. More specifically, the objective in this equation is to generate an artificial noise that maximizes the lower bound on the secrecy capacity, which is defined as the difference in mutual information between the transmitter-receiver pair and the transmitter-eavesdropper pair (eavesdropper's channel), as:

$$= {I}_{TR} - {I}_{TE} , where$$

is the lower bound on the secrecy capacity, ITR is the mutual information on the transmitter-receiver pair and ITE is the mutual information on the transmitter-eavesdropper pair.

In some non-limiting embodiments or aspects, SCA models are different, since there is no receiver as in the communication model, and the transmitter-receiver pair may not need to be considered. As a result, mutual information in the transmitter-receiver pair may be treated by artificial sequence generator 110 as a constant value (for example let ITR=0). In such an example, in view of securing communication, maximizing the secrecy capacity in SCAs is equivalent to minimizing the channel capacity in the transmitter-attacker (e.g., eavesdropper, hacker, etc.) pair, which in fact is the side-channel. Therefore, it is the objective problem to identify the noise sequence [symbol] that can minimize the channel capacity Cs of the side channel such that the energy expended on generating the noise sequence does not exceed a given bound Eₐ, as seen in the optimization equation:

$${C}_{s} , such that E [ {\vert {N}_{a} \vert}^{2} ] \leq {E}_{a} .$$

In some non-limiting embodiments or aspects, in [symbol] =pFNₐ, F is used to control the selection of the generation of the artificial impulsive noise. For a predefined P, a fixed p, and a given distribution of Nₐ, the rank of F determines how many impulsive noise samples will be generated and controls the total energy to be spent on the noise generation. Thus, the objective problem can be translated into [symbol] Cₛ, such that Rank(F)≤A, where Rank(·) is the rank of a given matrix, and A is the constraint on the number of impulse noises that can be generated by the noise generator:

$$A = \frac{{mE}_{A}}{{p}^{2} Tr ( E [ {N}_{a} {N}_{a}^{T} ] )} ,$$

From the optimization equation above, it is determined that minimizing the channel capacity Cₛ is equivalent to maximizing the energy of the artificial noise, such that the optimization equation is further modified as:

$${max}_{F} {p}^{2} Tr ( E [ Δ {N}_{a} {N}_{a}^{T} ] ) , such that Rank ( F ) \leq A .$$

In some non-limiting embodiments or aspects, artificial sequence generator 110 overlays each sample of artificial noise of the plurality of samples of artificial noise on a respective portion of a side channel signal after optimizing a solution with optimal energy efficiency.

In order to find the solution of the optimization problem in:

$${max}_{F} {p}^{2} Tr ( E [ Δ {N}_{a} {N}_{a}^{T} ] ) , such that Rank ( F ) \leq A ,$$

the matrix Δ, which is defined earlier to be Δ=F_{T}\hat{P}F is observed, and the set of indices of “1”s of the pre-defined matrix \hat{P} as Ω_{\hat{p}}.

In some non-limiting embodiments or aspects, under a given constraint A, there is a matrix F, where the set of the indices of “1's” in F is denoted by Ω_{F}. In this example, the set of the indices of “1”s in Δ is defined as ΩΔ. Due to the special property that both \hat{P} and F are diagonal matrices with only 0 and 1 values in their diagonals, Δ is also a diagonal matrix. Furthermore, Ω_{Δ}=Ω_{\hat{p}}∩Ω_{F} may also be satisfied (e.g., always satisfied, etc.).

In some non-limiting embodiments or aspects, if matrix Φₐ=NₐNₐ^{T}, with the diagonal elements ϕ(1≤ [symbol] ≤m), then:

$${p}^{2} Tr ( E [ Δ {N}_{a} {N}_{a}^{T} ] ) = {p}^{2} {\sum }_{i ∈ {Ω}_{Δ}} E [ {ϕ}_{i}^{2} ] = {cp}^{2} {Θ}_{a} ,$$

where c=|Ω_{Δ}| is the cardinality of Ω_{Δ}, and Θₐ=σ2−μₐ². In such an example, the maximization of this equation relies on c, which is eventually determined by \hat{P} and F (under the constraint of A). In such an example, the solution under the following cases, which differ in the level of compression of the observed data, comprise at least:
a) Ω_{\hat{p}}>A: In this example, considering the system is sensitive to the energy consumption, such as some small-sized IoT devices, the number of selected leakage samples exceeds the budget of samples to which impulsive noise may be injected. The energy allowed for noise generation is therefore limited. In this example, the maximum rank that F can obtain is nk(F)=A. In order to maximize |Ω_{Δ}|, it requires that Ω_{F}=Ω_{\hat{p}}∩Ω_{F}, as now |Ω_{F}|=A<|Ω_{\hat{p}}|. Based on Ω_{Δ}=Ω_{\hat{p}}∩Ω_{F}, have |Ω_{Δ}|=A. Thus, the maximum value for the above equation is

$${max}_{F} {p}^{2} Tr ( E [ Δ {N}_{a} {N}_{a}^{T} ] ) = A {p}^{2} {Θ}_{a} ,$$

and the corresponding optimum F is:

$${F}^{*} = \{ F \vert {Ω}_{F} ⊆ {Ω}_{\hat{p}} , \vert {Ω}_{F} \vert = A \} ,$$

where Ω_{F} of F is any subset of Ω_{\hat{p}}, with |Ω_{F}|=A. In order to save the computing cost in vulnerable device 102, Ω_{F} is set (e.g., fixed to a given specific system, etc.), once the random choice of a subset is generated.
b) |Ω_{\hat{p}}|≤A: In some non-limiting embodiments or aspects, the system is friendly to the energy consumption, in this case the energy budget exceeds the number of selected leakage samples. Hence, the maximum of |Ω_{Δ}|≤A is obtained only if Ω_{\hat{p}}=Ω_{\hat{p}}∩Ω_{F}, which means Ω_{\hat{p}}⊆Ω_{F} is needed.

In some non-limiting embodiments or aspects, although the maximum rank of F that may be obtained is A, it may be unnecessary to obtain this maximum for F. Actually, based on Ω_{F}=Ω_{\hat{p}}∩Ω_{F} and Ω_{\hat{p}}=Ω_{\hat{p}}∩Ω_{F}, only Ω_{\hat{p}}=Ω_{F} is needed. In such an example, the maximum value for

$${p}^{2} Tr ( E [ △ {N}_{a} {N}_{a}^{T} ] ) = {p}^{2} {\sum }_{i ∈ {Ω}_{Δ}} E [ {ϕ}_{i}^{2} ] = {cp}^{2} {Θ}_{a} ,$$

$${max}_{F} {p}^{2} Tr ( E [ △ {N}_{a} {N}_{a}^{T} ] ) = {Ω}_{\hat{p}} {p}^{2} {Θ}_{a} ,$$

and the corresponding optimum solution of F is F*=\hat{P}.

In summary, to solve the optimization equation (e.g., optimization problem, etc.) the optimum solution of F is obtained by:

$${F}^{∗ ⋆} = \{ \begin{matrix}\{ F \vert {Ω}_{F} ⊆ {Ω}_{\hat{p}} , \vert {Ω}_{F} \vert = A , & if \vert {Ω}_{\hat{p}} \vert \leq A \\ \hat{P} , & if \vert {Ω}_{\hat{p}} \vert \leq A\end{matrix} ,$$

where, after obtaining the optimal design of F, artificial sequence generator 110 may translate F* to the state-transition matrix G*: such that the diagonal of F* is represented by F*_{d}. Then from i=1, 2, . . . , m, if F*_{d}[i]==1, set sᵢ=F*_{d} [1:i]. In this example, based on the obtained states, the transition matrix can be reconstructed through:

$$G = [ \begin{matrix}{β}_{1 , 1} & {β}_{1 , 2} & … & {β}_{1 , n} \\ {β}_{2 , 1} & {β}_{2 , 2} & ⋮ & {β}_{2 , n} \\ ⋮ & ⋮ & ⋱ & ⋮ \\ {β}_{n , 1} & {β}_{n , 2} & … & {β}_{n , n}\end{matrix} ] .$$

In some non-limiting embodiments or aspects, returning to

$$\{ \begin{matrix}\{ F \vert {Ω}_{F} ⊆ {Ω}_{\hat{p}} , \vert {Ω}_{F} \vert = A , & if \vert {Ω}_{\hat{p}} \vert \leq A \\ \hat{P} , & if \vert {Ω}_{\hat{p}} \vert \leq A\end{matrix} ,$$

a theoretical solution is provided for how to design the optimal energy-efficient artificial noise sequence. In order to apply the designed scheme to more practical scenarios, the energy efficiency of the proposed scheme and also its energy efficiency to other schemes may be determined and compared. In some non-limiting embodiments or aspects, the solution may additionally handle the case, such that, the system's noise generator and the attacker have selected (e.g., chosen, etc.) different sampling methods.

In some non-limiting embodiments or aspects, artificial sequence generator 110 overlays each sample of artificial noise of the plurality of samples of artificial noise on a respective portion of a side channel signal after analysis of the noise sequence generation scheme. For example, the energy efficiency of the noise generation methods, and the performance boundary of the design for the real applications may be evaluated.

In some non-limiting embodiments or aspects, a metric is generated for determining an effectiveness and efficiency. The former comes in terms of reduction of the success of the attack and the latter in terms of expended energy. The measure (i.e., the energy efficiency (EE)), combines effectiveness and efficiency by measuring the reduction of the attack success rate per unit of energy spent to generate the noise. This is expressed by:

$$E E = \frac{1 - Successful\_Key \_Recovery}{Noise\_Energy} ,$$

where noise energy is the total energy that is spent in generating the noise sequences during an attack. In this example, the noise energy is equal to the sum of the energy of all noise sequences that are injected into the leakage traces that are collected by the attacker. Thus, when a random noise sequence is generated, the result:

$$Noise Engery = {\sum }_{i = 1}^{I} E [ {\vert {N}_{r}^{( i )} \vert}^{2} ] ,$$

while in the case of the artificial noise sequences, the result:

$$Noise Engery = {\sum }_{i = 1}^{I} E [ {\vert \vert}^{2} ] ,$$

where Nᵣ⁽ⁱ⁾ (or [symbol] ) is the noise sequence that has been added to the i-th leakage trace and I is the total number of leakage traces collected by the attacker. In some non-limiting embodiments or aspects, successful key recovery is a binary value, which indicates whether the attacker is able to recover the secret value despite the noise sequences. If the attacker recovers the key, the value of EE is zero, or alternatively, the larger the value of EE, the less the amount of energy to spend (or spent) to cause an unsuccessful attack.

In some non-limiting embodiments or aspects, to evaluate the energy efficiency of a proposed scheme and other noise generation based methods, the energy efficiency equation is used:

$$E E = \frac{1 - Successful\_Key \_Recovery}{Noise\_Energy} ;$$

In this example, more results about the energy efficiency evaluations will be introduced in the experimental part.

In some non-limiting embodiments or aspects, choice of sampling methods may determine the optimal noise generation scheme to rely on for a sampling method that has been chosen for the system in advance. Moreover, in this example, the given solution is optimal only when both the system and the attacker choose the same data sampling method. However, in practice, the sampling method chosen by the system during the design phase is likely different from the sampling method that is later used by the attacker. For example, the system may choose 20 ppc to construct the artificial noise generator during the design phase, but the attacker may decide to use 3 ppc during profiling and attack. Obviously, the system designer does not know which exact compression method that potential attackers will choose in the future. While in addition, once the noise generator is sealed into the system, the attacker also has no way to guess the sampling method utilized by the system.

In some non-limiting embodiments or aspects, however, the widely used sampling methods are largely similar. For example, the methods SNR and SOST are actually the same if the variance at each sample point is considered to be independent. Similarly, in the DOM family of sampling methods, the samples selected by each method (1 ppc, 3 ppc, etc.) share a common support. For example, if Ω1 and Ω3 are the set of indices of samples selected from the raw leakage trace by 1 ppc and 3 ppc respectively, the samples collected from 1 ppc are always contained in those collected by 3 ppc, that is, Ω1 and Ω3 always hold. Generally, due to this similarity across all these sampling methods, the solution in

$$\{ \begin{matrix}\{ F \vert {Ω}_{F} ⊆ {Ω}_{\hat{p}} , \vert {Ω}_{F} \vert = A , & if \vert {Ω}_{\hat{p}} \vert \leq A \\ \hat{P} , & if \vert {Ω}_{\hat{p}} \vert \leq A\end{matrix} ,$$

given by any sampling method, is closely related to the solutions given by the other methods, under the same constraint.

In some non-limiting embodiments or aspects, in determining the sampling method to select, a trade-off may exist between the scalability of data compression and the amount of energy to be spent for noise sequence generation. For example, if a high-compression method is chosen by the designer, such as 1 ppc, more energy is saved in noise generation, but the noise sequence generated by this method may not cover all the useful sample points that will be picked by the attacker if they choose a weaker compression method, such as 20 ppc. Similarly, if the designer chooses a very weak compression scheme, such as allap, the generated noise sequence may well mask the majority of the leakage samples that contain useful information, but more energy will be spent. As a result, selecting an appropriate compression method during system design is fundamentally a trade-off between efficiency (what energy budget may be sought for artificial noise generation) and effectiveness (what level of protection may be sought against SCAs).

In some non-limiting embodiments or aspects, the effectiveness to generate noise samples to corrupt the useful samples inside the raw leakage trace are based on timing. Ideally, the noise samples generated are expected to be exactly injected into the leakage samples that have the same or approximate timing. However, in practice, due to the likely delay introduced by hardware circuit, sometimes the generated noise sequence may not be exactly matched with the leakage trace, for example, the starting point of two sequences is different.

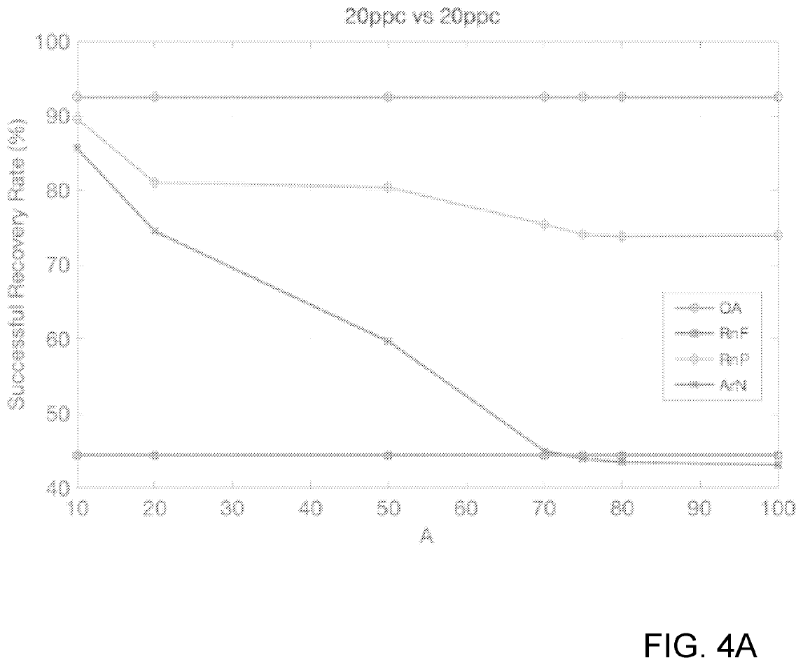

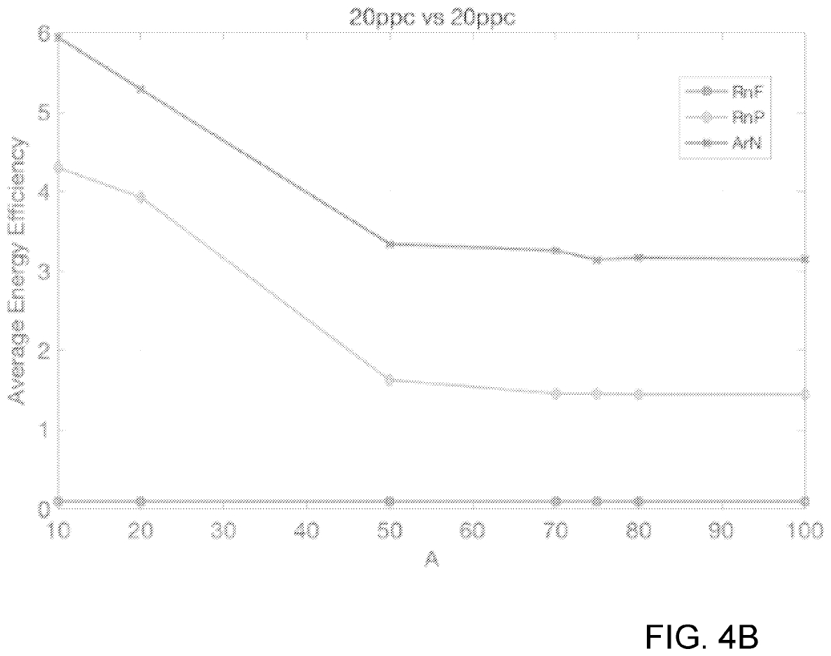

FIGS. 4A and 4B are illustrations of a probability of successful recovery for energy efficient generation of artificial noise to prevent SCAs according to some non-limiting embodiments or aspects. In some non-limiting embodiments or aspects, FIG. 4A illustrates a probability of successful recovery (FIG. 4A), and FIG. 4B illustrates Average EE (FIG. 4B). Experimental results were collected on the Grizzly benchmark dataset (“Grizzly”). Grizzly is based on leakage data collected from the data bus of the Atmel XMEGA 256 A3U, which is a widely used 8-bit micro-controller. While the use of data with 8-bit secrets may appear overly simplistic, it is well suited for the evaluation of the energy efficiency of countermeasures. Given the 8-bit nature of the system, there are 256 keys. For each key k∈{0, 1, . . . , 255}, 3072 raw traces are recorded. These traces are divided into two sets: a profiling set and an attack set. Each raw trace has 2500 samples, and each sample represents the total current consumption in all CPU ground pins.

The attack algorithm in the experiment results is a linear model based template attack. In this attack, the leakage function is represented by a linear model (e.g., a Stochastic Model in this context, etc.), and during profiling of the leakage function the model is estimated by solving linear equations over a subset of keys. Based on the estimated leakage function, the template (e.g., in a form of Gaussian Model, etc.) for each key is generated. In the attack phase, a candidate key with a maximum likelihood in matching is selected. In the experiments, all keys (e.g., 256 keys, etc.) may be used for profiling the leakage function. As a baseline for key recovery, the results of the original template attack (i.e., denoted by OA) include the version of the experiment without injecting noise sequence generations into the raw traces.

In some non-limiting embodiments or aspects, the sampling methods in the experiments include 3 ppc, 20 ppc, and allap (e.g., typical compression methods in SCAs, etc.). In the Grizzly dataset, the number of samples obtained by these methods in each trace typically are: 18˜30 for 3 ppc, 75˜79 for 20 ppc, and 125 for allap, respectively. As discussed hereinabove, the sampling method is selected based on system performance requirements, such as the security level, the energy consumption budget, and/or the like.

In some non-limiting embodiments or aspects, the noise generation scheme may be evaluated against other methods, such as a random full sequence and a random partial sequence. The random full sequence generates random noise at all time. As a result, all leakage samples (e.g., 2,500 of them in this experiment, etc.) are covered by random noise samples. Random partial sequence improves over random full sequence by generating noise for adding onto only a randomly selected subset of the raw leakage samples. In order to fairly compare random partial sequence to a scheme, both methods generate the same number |Ω_{F}| of noise samples. As a result, the two scheme only differ in the selection of raw leakage samples to inject the noise into.

In the following, the term “ArN” may be used to denote the proposed artificial noise method, and the terms “RnF” and “RnP” may denote random full sequence and random partial sequence, respectively.

In some non-limiting embodiments or aspects, during the attack phase, for each key k, the attack is independently executed, for example the attack is executed 100 times by randomly picking the leakage traces from the attacking set. The successful recovery rate (SRR) is used to measure the attack performance, which is the average success probability over all keys:

$$Successful Recovery Rate = \frac{{\sum }_{k = 0}^{{2}^{B} - 1} {P}_{attack} ( k )}{{2}^{B}} ,$$

where

$${P}_{attack} ( k ) = \frac{{N}_{h i t ( k )}}{{N}_{T}} .$$

In this example, NT is the number of tests (e.g., in this case, NT=100, etc.) and Nₕᵢₜ₍ₖ₎ defines for how many times that key k is successfully guessed during all NT tests. In the following, a noise generation method that most efficiently decreases the key recovery rate is identified in the experimental results.

In some non-limiting embodiments or aspects, the EE for an attack is defined by:

$$E E = \frac{1 - Successful\_Key \_Recovery}{Noise\_Energy} .$$

In some non-limiting embodiments or aspects, EE_{avg} is used to measure the average energy efficiency of the noise generation for all keys, defined as:

$$E {E}_{avg} = \frac{{\sum }_{k = 0}^{{2}^{B} - 1} \frac{{\sum }_{t = 1}^{{N}_{T}} E E ( k , t )}{{N}_{T}}}{{2}^{B}} ,$$

where EE(k, t) is the EE value for an attack on key k in t-th test. To scale the result, Noise Energy above is normalized, based on the equation:

$$Noise Engery = \frac{Noise Engery}{{N}_{T} \cdot 2500 \cdot {σ}^{2}} ,$$

where σ is the variance of the generated noise sequence, and the constant 2500 is the number of sample per trace in the energy experiments.

In order to fairly compare all noise generation methods, both noise vector N_{R} and noise vector N_{A} are generated from the same distribution. The parameters of the noise distribution are obtained from the raw leakage trace (e.g., raw leakage traces are collected under k=0 to compute the mean and variance, etc.). In this example, the independent and identically distributed noise vector is generated for each noise generation method based on the obtained parameters.

During the system design phase, 1000 traces are used to compute the matrix P for any given compression method.

With continuing reference to FIG. 4, the results of the successful recovery rate and the average EE for different values of A according to non-limiting embodiments or aspects (e.g. Iₐ and Iₚ to denote the number of profiling and attack traces for each key, respectively, etc.). The number of attack traces Iₐ and the number of profiling traces I_{P} are all fixed to 500. Initially, both the system designer and the attacker are assumed to select a same sampling method: 20 ppc, the gain is p=1 to control the overhead of the generated noise sequences. As OA has no noise generator, and RnF always covers the full size of leakage trace, the value of A is irrelevant to them. The experiments are repeated N_{T}·T_{A} times before taking the average, where T_{A} is the number of different A. Finally, the constant values of SRR and EE_{avg} are obtained for OA and RnF under different A: the SRRs of OA and RnF are 91.64% and 44.43%, and the E_{avg} of RnF is 0.094. Note that EE has no meaning for OA.

The results indicate that for small numbers of A (e.g., less than 50), ArN gets a better recovery rate (i.e., is less effective) compared to RnF. This is because now only a partial solution of F is obtained. When A≥75, which is also the lower bound of the number of samples by 20 ppc, ArN can get the full or approximate full solution of F. As a result, ArN achieve full effectiveness, which is also verified from the experimental results that now both ArN and RnF allow for almost the same recovery rates. However, when observing the EE values, it can be clearly identified that ArN always displays a good EE value. This result proves that to achieve a same level of security, the benefits in spending much less energy is achieved as compared to the RnF. For example, when A≥70, the EE values of ArN stay around 3.2, which is better (e.g., preferred, etc.) than RnF.

In some examples, the effectiveness (e.g., resistance, etc.) of RnP is worse compared to the other two noise generation methods. As both RnP and ArN generate the same number of noise samples, RnP's EE values are always worse than ArN's. The energy experiment also shows that an effectiveness of a proposed model relies on the generation of the noise samples being artificially designed and particularly targeted for the useful leakage samples. In such an example, it may be meaningless to compare the EE values of RnF and RnP, since they don't have a same or an approximate value in either the energy cost or the recovery rate.

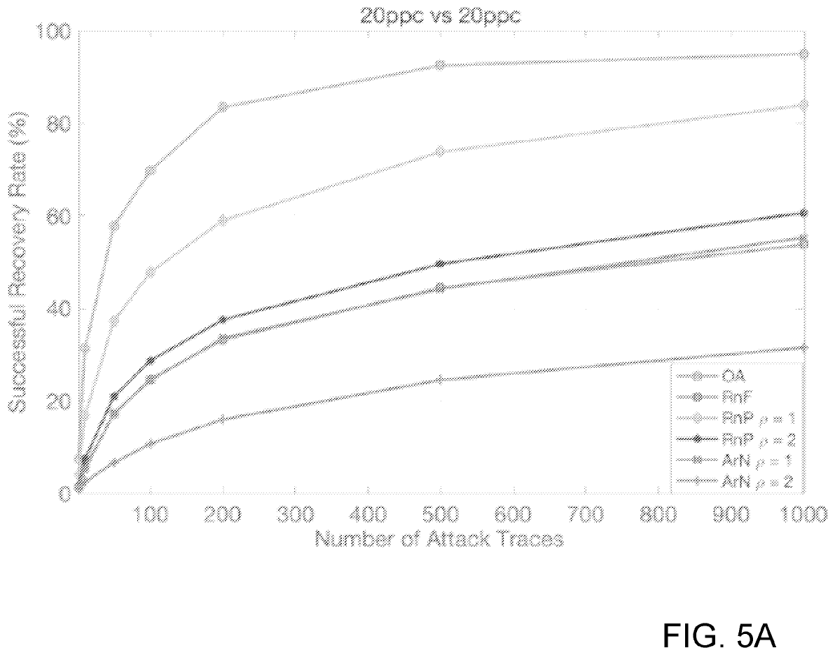

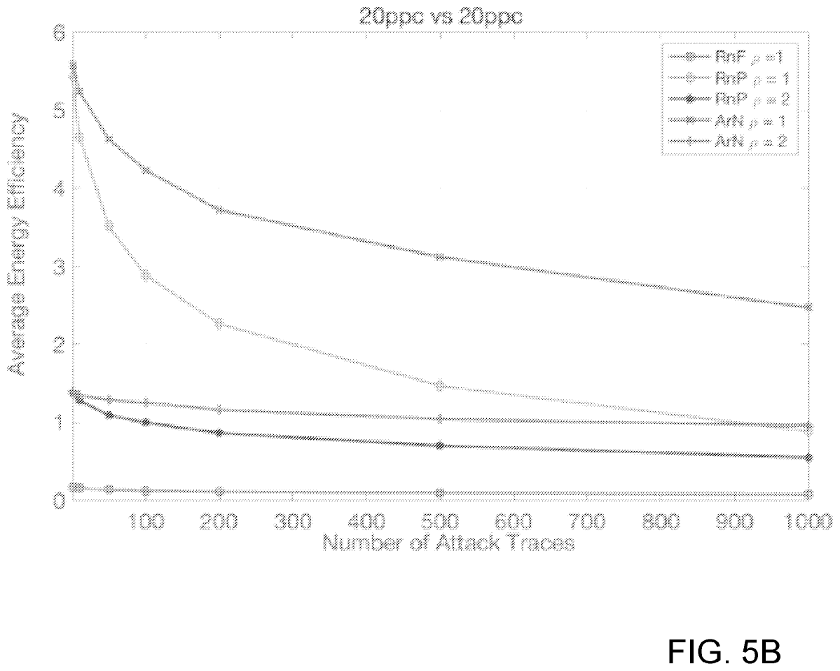

With reference to FIGS. 5A and 5B, an illustration of a probability of successful recovery for energy efficient generation of artificial noise to prevent SCAs according to a non-limiting embodiment is provided. With further reference to FIG. 5, a probability of (FIG. 5A), and Average EE (FIG. 5B), are shown in contrast to different attack traces Iₐ, with a same sampling method 20 ppc for system and attacker. In some non-limiting embodiments or aspects, FIGS. 5A and 5B illustrate a probability of successful recovery versus different A, with a same sampling method 20 ppc for system and attacker.

For example, FIGS. 5A and 5B show the recovery rates and EE values with different numbers of Iₐ. In addition, Iₚ remains 500, and Iₐ varies from 1 to 1000. In such an example, both the designer and attacker are assumed to choose 20 ppc as the sampling method. The value of A is set to 100, which allows for F to obtain the full solution. The results for gain p=1 for all the noise generation methods, and then compare this to the use of increased gain, p=2, for ArN and RnP (nowE′_{A}=4E_{A}). With increasing numbers of attack traces, the recovery rate of the original template attack, and also of all the noise generation methods, increases. This is true because the noise can be eliminated when a large number of traces are collected and averaged. However, when p=1, even in the case of Iₐ=1000, ArN can still decrease the recovery rate from 95% (the template attack's number) to 55.27%, which is significant. At the same time, ArN also has the maximum average EE value, around 2.47, compared to other two noise generation methods. Still, this is also another good proof that compared to RnF, even under the same design on the noise's amplitude (the gain), the method can always expend much less energy, in order to get the same security level.

In some non-limiting embodiments or aspects, by increasing the gain factor p to 2, in Iₐ=1000, ArN may decrease the recovery rate to 31.52% with average EE of 0.9587, which is about 12.5 times better than the EE value of RnF (0.0766) when p=1, and about 1.74 times better than the EE value of RnP (0.5508) when p=2, but the recovery rate for both of these two methods is larger than ArN, by at least a 20% increase. This also shows a fact that compared to RnF, ArN can generate the noise sequence to strongly enhance the security level on the system, but with much less energy to be spent. In general, the experimental data proves the significant energy efficiency of the method.

Naturally, it is unlikely that the attacker will select the same compression method that the system designer implements for designing the noise sequence. In some non-limiting embodiments or aspects, it is determined which sampling method is most suitable to use in system design for generating the artificial noise samples on the Atmel XMEGA 256 micro-controller (e.g., the platform that Grizzly dataset is collected from, etc.) for countering SCAs. In some non-limiting embodiments or aspects, the effects of the attacker choosing different selection methods than what the designer had in mind may be determined by comparing the recovery rates and EE values for all possible combinations of compression methods selected by the designer and attacker. For example, Iₐ and I_{P} may still be fixed to 500. The value of A is set to 150, such that the full solution of F can be guaranteed under any sampling method. The gain p is set to 1. Here SD and SA stand for the sampling method that is chosen by system designer and the system attacker, respectively. In this example, since no noise sequence is generated under OA and RnF, it is not affected by the sampling methods chosen by the designer, and recovery rates and EE values will only differ for different attackers when different sampling methods are used.

In some non-limiting embodiments or aspects, if the attacker chooses 3 ppc, ArN always has lower recovery rates compared to other sampling methods. This is a reasonable result since only very limited leakage samples are picked under 3 ppc. In general, no matter which defending methods is applied, the attacker will always get a lower recovery rate by using 3 ppc compared to the other two sampling methods, which makes 3 ppc a poor choice for the attacker in practice. Based on the cases of (3 ppc, 20 ppc) and (3 ppc, allap), ArN experiences much higher recovery rates compared to RnF. Hence, SD=3 ppc is a poor choice for the system designer as well, even if it brings significant saving in energy cost. In the case where the system designer selects allap as SD, in general, with respect to time, the recovery rates of ArN are lower compared to the cases of other sampling methods chosen as SD, under a same SA. For example, when under (allap, allap), the recovery rate of ArN is only 42.25%. But the recovery rate becomes 54.32% when under (20 ppc, allap). However, when checking the EE values, for any fixed attacker's sampling method SA, using 20 ppc as SD in defending is always more energy-efficient than using allap (e.g., 3.1175 is determined in (20 ppc, 20 ppc) and 1.8543 is determined in (allap, 20 ppc), similarly, 2.3541 is determined in (20 ppc, allap) and 1.9148 in (allap, allap), etc.). As discussed, the recovery rate for ArN in (20 ppc, allap) is about 12% higher than in (allap, allap), but it is noticed that 54.32% is also not an unacceptable number, especially compared to RnP in the same case (73.18%). In this example, considering both the energy efficiency and the practicability in application, 20 ppc may be recommended as the first choice in the system design (i.e., for the Grizzly dataset). In practice, to design the artificial noise generator for other systems, the designers may also perform similar computations as in FIGS. 4A, 4B, 5A and 5B, and then select the sampling method based on the comparison of the values of both the effectiveness and the efficiency in each different (SD, SA) combinations, under the specific system's requirements (e.g., an energy consumption budget, gain, etc.).

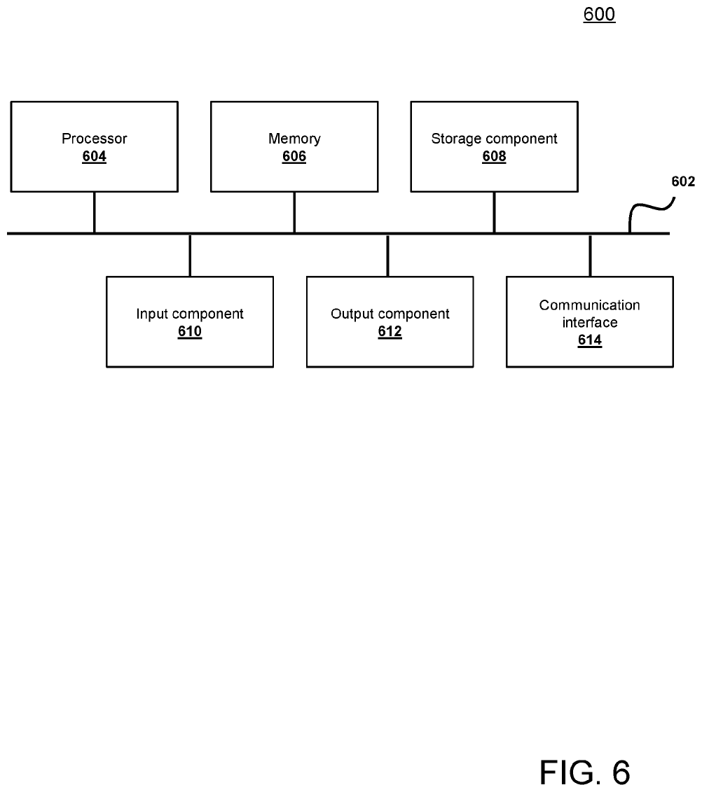

Referring now to FIG. 6, shown is a diagram of example components of a device 600, according to some non-limiting embodiments or aspects. Device 600 may correspond to vulnerable device 102, issuer system 104, cardholder device 106, payment processing system 108, and artificial sequence generator 110 of FIG. 1, as an example. In some non-limiting embodiments or aspects, such systems or devices may include at least one device 600 and/or at least one component of device 600. The number and arrangement of components shown are provided as an example. In some non-limiting embodiments or aspects, device 600 may include additional components, fewer components, different components, or differently arranged components than those shown in FIG. 1. Additionally, or alternatively, a set of components (e.g., one or more components) of device 600 may perform one or more functions described as being performed by another set of components of device 600.

As shown in FIG. 6, device 600 may include bus 602, processor 604, memory 606, storage component 608, input component 610, output component 612, and communication interface 614. Bus 602 may include a component that permits communication among the components of device 600. In some non-limiting embodiments or aspects, processor 604 may be implemented in hardware, firmware, or a combination of hardware and software. For example, processor 604 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 606 may include random access memory (RAM), read only memory (ROM), and/or another type of dynamic or static storage device (e.g., flash memory, magnetic memory, optical memory, etc.) that stores information and/or instructions for use by processor 604.

With continued reference to FIG. 6, storage component 608 may store information and/or software related to the operation and use of device 600. For example, storage component 608 may include a hard disk (e.g., a magnetic disk, an optical disk, a magneto-optic disk, a solid state disk, etc.) and/or another type of computer-readable medium. Input component 610 may include a component that permits device 600 to receive information, such as via user input (e.g., a touch screen display, a keyboard, a keypad, a mouse, a button, a switch, a microphone, etc.). Additionally, or alternatively, input component 610 may include a sensor for sensing information (e.g., a global positioning system (GPS) component, an accelerometer, a gyroscope, an actuator, etc.). Output component 612 may include a component that provides output information from device 600 (e.g., a display, a speaker, one or more light-emitting diodes (LEDs), etc.). Communication interface 614 may include a transceiver-like component (e.g., a transceiver, a separate receiver and transmitter, etc.) that enables device 600 to communicate with other devices, such as via a wired connection, a wireless connection, or a combination of wired and wireless connections. Communication interface 614 may permit device 600 to receive information from another device and/or provide information to another device. For example, communication interface 614 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 600 may perform one or more processes described herein. Device 600 may perform these processes based on processor 604 executing software instructions stored by a computer-readable medium, such as memory 606 and/or storage component 608. A computer-readable medium may include any non-transitory memory device. A memory device includes memory space located inside of a single physical storage device or memory space spread across multiple physical storage devices. Software instructions may be read into memory 606 and/or storage component 608 from another computer-readable medium or from another device via communication interface 614. When executed, software instructions stored in memory 606 and/or storage component 608 may cause processor 604 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed to” or “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
storing, with a device, at least one secret value comprising secret value bits;
executing, with a cryptographic subsystem of the device, at least one cryptographic operation based on the at least one secret value;
storing, with an artificial sequence generator, at least one state indication based on a plurality of previous cryptographic operations executed on the device;
generating, with the artificial sequence generator, a plurality of samples of artificial noise, wherein a number of the plurality of samples is based on at least one power constraint parameter; and
overlaying, with the artificial sequence generator, each sample of artificial noise of the plurality of samples of artificial noise over a respective portion of a side channel signal based on the at least one state indication to mask leakage information associated with the at least one secret value on the side channel signal.

2. The computer-implemented method of claim 1, wherein generating the plurality of samples of artificial noise comprises generating the plurality of samples of artificial noise based on a Gaussian random vector, a selection matrix, and a signal constraint parameter,
wherein the at least one power constraint parameter comprises the signal constraint parameter and a rank parameter, and
wherein the selection matrix comprises a diagonal matrix having a rank less than the rank parameter.

3. The computer-implemented method of claim 2, wherein the signal constraint parameter comprises a direct current (DC) component and an alternating current (AC) component.

4. The computer-implemented method of claim 1, wherein the at least one state indication comprises a plurality of state indications, each state indication of the plurality of state indications associated with a respective time that the cryptographic subsystem is processing the at least one secret value during execution of the at least one cryptographic operation, and
wherein overlaying each sample of artificial noise of the plurality of samples of artificial noise comprises overlaying each sample of artificial noise over the respective portion of the side channel signal based on the respective time that the cryptographic subsystem is processing the at least one secret value.

5. The computer-implemented method of claim 1, wherein the side channel signal comprises a signal on a side channel, the side channel having a channel capacity that is logarithmically proportional to a signal to noise ratio (SNR) of the side channel, the SNR being inversely proportional to each respective sample of artificial noise, wherein overlaying each respective sample of artificial noise comprises reducing the channel capacity by reducing the SNR.

6. The computer-implemented method of claim 1, further comprising predicting with the artificial sequence generator, an approximate time during which the cryptographic subsystem will be executing the at least one cryptographic operation based on the at least one state indication.

7. The computer-implemented method of claim 6, wherein predicting the approximate time, comprises:
generating the plurality of samples of artificial noise based on a random vector and a sample rate for overlaying each sample of artificial noise over the respective portion of the side channel signal.

8. The computer-implemented method of claim 1, further comprising:
selecting a number of the plurality of samples of artificial noise based on a rank of a selection matrix and the at least one power constraint.

9. The computer-implemented method of claim 1, wherein a leakage trace available on a side channel of the side channel signal comprises a linear combination of an original leakage trace resulting from the cryptographic subsystem executing the at least one cryptographic operation, naturally occurring noise on the side channel, and the plurality of samples of artificial noise.

10. The computer-implemented method of claim 1, wherein the side channel signal comprises a power sign or an electromagnetic signal.

11. A system, comprising:
at least one processor; and
at least one non-transitory computer readable medium comprising one or more instructions that, when executed by the at least one processor, cause the at least one processor to:
store at least one secret value comprising secret value bits;
execute at least one cryptographic operation based on the at least one secret value;
store at least one state indication based on a plurality of previous cryptographic operations executed on a device;
generate a plurality of samples of artificial noise, wherein a number of the plurality of samples is based on at least one power constraint parameter; and
overlay each sample of artificial noise of the plurality of samples of artificial noise over a respective portion of a side channel signal based on the at least one state indication to mask leakage information associated with the at least one secret value on the side channel signal.

12. The system of claim 11, wherein the one or more instructions, when executed by the at least one processor, further cause the at least one processor to generate the plurality of samples of artificial noise based on a Gaussian random vector, a selection matrix, and a signal constraint parameter,
wherein the at least one power constraint parameter comprises the signal constraint parameter and a rank parameter, and
wherein the selection matrix comprises a diagonal matrix having a rank less than the rank parameter.

13. The system of claim 12, wherein the signal constraint parameter comprises a direct current (DC) component and an alternating current (AC) component.

14. The system of claim 11, wherein the at least one state indication comprises a plurality of state indications, each state indication of the plurality of state indications associated with a respective time that the cryptographic subsystem is processing the at least one secret value during execution of the at least one cryptographic operation, and
wherein overlaying each sample of artificial noise of the plurality of samples of artificial noise comprises overlaying each sample of artificial noise over the respective portion of the side channel signal based on the respective time that the cryptographic subsystem is processing the at least one secret value.

15. The system of claim 11, wherein the side channel signal comprises a signal on a side channel, the side channel having a channel capacity that is logarithmically proportional to a signal to noise ratio (SNR) of the side channel, the SNR being inversely proportional to each respective sample of artificial noise, wherein overlaying each respective sample of artificial noise comprises reducing the channel capacity by reducing the SNR.

16. The system of claim 11, wherein the one or more instructions, when executed by the at least one processor, further cause the at least one processor to:
predict an approximate time during which the cryptographic subsystem will be executing the at least one cryptographic operation based on the at least one state indication.

17. The system method of claim 16, wherein the one or more instructions, when executed by the at least one processor, further cause the at least one processor to:
generate the plurality of samples of artificial noise based on a random vector and a sample rate for overlaying each sample of artificial noise over the respective portion of the side channel signal.

18. The system of claim 11, wherein the one or more instructions, when executed by the at least one processor, further cause the at least one processor to:
select a number of the plurality of samples of artificial noise based on a rank of a selection matrix and the at least one power constraint.

19. The system of claim 11, wherein a leakage trace available on a side channel of the side channel signal comprises a linear combination of an original leakage trace resulting from the cryptographic subsystem executing the at least one cryptographic operation, naturally occurring noise on the side channel, and the plurality of samples of artificial noise.

20. A computer program product comprising at least one non-transitory computer-readable medium having instructions stored thereon that, when executed by at least one computing device, cause the at least one computing device to:
store at least one secret value comprising secret value bits;
execute at least one cryptographic operation based on the at least one secret value;
store at least one state indication based on a plurality of previous cryptographic operations executed on the device;
generate a plurality of samples of artificial noise, wherein a number of the plurality of samples is based on at least one power constraint parameter; and
overlay each sample of artificial noise of the plurality of samples of artificial noise over a respective portion of a side channel signal based on the at least one state indication to mask leakage information associated with the at least one secret value on the side channel signal.
